(19) United States
(12) Patent Application Publication
(10) Pub. No.: US 2009/0307294 A1
(43) Pub. Date: Dec. 10, 2009

(54) Conversion Between Sub-Band Field Representations for Time-Varying Filter Banks

(76) Inventors: Guillaume Picard, Paris (FR); Abdellatif Benjelloun Touimi, Lannion (FR)

Correspondence Address: MCKENNA LONG & ALDRIDGE LLP, 1900 K STREET, NW, WASHINGTON, DC, 20006, US

(21) Appl. No.: 12/227,241

(22) PCT Filed: May 14, 2007
(86) PCT No.: PCT/FR2007/051266

§ 371 Date: Jun. 19, 2009

(30) Foreign Application Priority Data
May 19, 2006 (FR) 0604507

(51) Int. Cl. G06F 17/10

(52) U.S. Cl. 708/300

(57) ABSTRACT

Conversion between sub-band field representations for time-dependent filter banks. The invention relates to a transcoding processing operation between different sub-band fields, aiming to compact the application of a first vector representing the signal in a first sub-band field to a synthesis filter bank, and then to an analysis filter bank, in order to obtain a second vector representing the signal in a second sub-band field. In particular, the synthesis bank and/or the analysis bank are time-dependent. Within the scope of the invention, matrix filtering of the first vector is anticipated in order to directly obtain the second vector, this matrix filtering being represented by a global conversion matrix comprising pre-calculated sub-blocks of matrices (Aᵢ₀, . . . , Aᵢₚ₂₋₁) taking into consideration possible time-dependent variations in the filter banks, then stored into memory. The global conversion matrix is then constructed by calls to the memory in order to obtain the sub-blocks at pre-calculated successive instants.

The present invention relates to data processing for code conversion.

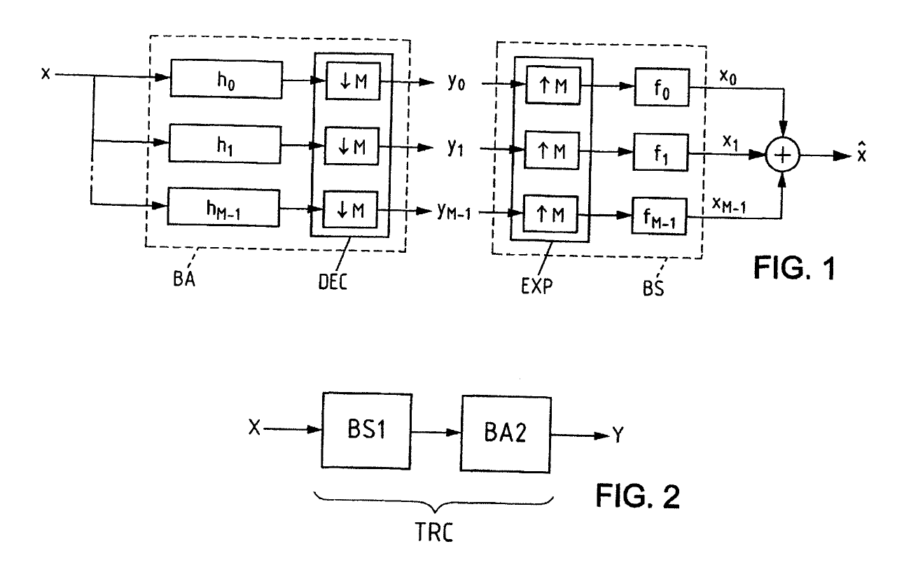

A signal processing operation, notably for compression coding, aims to bring a signal into a sub-band field. Referring to FIG. 1, this processing operation consists in applying a bank of analysis filters BA to a first expression x of the signal (for example time) including, where appropriate, an undersampling (decimation) DEC, to obtain a second expression of the signal (y₀, y₁, . . . , y_{M-1}) in the abovementioned sub-band field. Conversely, to retrieve the first expression of the signal \hat{x}, from its second expression (y₀, y₁, . . . , y_{M-1}), a bank of synthesis filters BS is applied to the second expression (y₀, y₁, . . . , y_{M-1}), including an oversampling (expansion) EXP.

The so-called “code conversion” processing operation then aims for a conversion between different sub-band fields. Referring to FIG. 2, to implement this type of processing operation, an effort is made to compact in one and the same step TRC the application of a first vector X representing the signal in a first sub-band field to a bank of synthesis filters BS1, then to a bank of analysis filters BA2, to obtain a second vector Y representing the signal in a second sub-band field. The respective notations BS1 and BS2 of the synthesis and analysis banks are justified by the fact that the bank BS1 relates to the conversion into the first sub-band field, whereas the bank BA2 relates to the conversion into the second sub-band field.

The code conversion is a crucial point in the communication of a digital signal (audio, video, multimedia, more generally, a signal representing any data).

In practice, the diversity of the coding formats supported by different terminals and used for communicating signals, often raises problems of incompatibility, notably in certain content delivery applications. The code conversion for the adaptation of the format of a signal to the type of decoding supported by a playback terminal provides a solution to this problem.

The conventional code conversion technique often introduces an additional algorithmic delay and involves a certain processing complexity.

The so-called “intelligent” code conversion aims to reduce these parameters. When processing digital audio signals in particular, the coders used are based on transform coding. Often, different compression formats use different types of transforms or “filter banks”. A first difficulty to be overcome therefore entails producing effective structures for changing between different sub-band field representations, notably when the number of filters of a bank of a first sub-band field is different from the number of filters of a bank of a second field.

One general solution to this problem was proposed in the document FR-2,875,351 and aims for a single matrix filtering, replacing the successive application of the synthesis bank of the first field and of the analysis bank of the second field, this single filtering being represented by a square matrix with a dimension that is the smallest common multiple of the numbers of filters per bank respectively in the first and in the second domains.

Nevertheless, an additional difficulty may arise, linked to the fact that the abovementioned filter banks can vary in time.

In practice, most of the current coders (MPEG-4, AAC, Dolby AC-3) use time-varying filter banks, whereas the conversions between different sub-band fields that have been proposed in the state of the art are applicable only for corresponding time/frequency representations that do not vary in time.

In particular, the most recent coders (notably in MPEG-2/4 AAC standardized coding, or in Dolby AC-3 type coding, for digital audio signals) use time/frequency representations where the resolution can vary in time. The resolution depends in particular on the short-term properties of the signal being processed. In this case, the coefficients defining the banks of analysis and synthesis filters applied for the change from a first to a second sub-band field and vice versa, vary in time and the main equations of the conversion system, proposed in the abovementioned document FR-2,875,351, can no longer be applied directly. Thus, to extend the application of the code conversion to the case of a variability as a function of time, the conversion equations between representations of the signal in different sub-band fields must make it possible to deal with the case of the most recent perceptual coders in which time-varying filter banks are used.

The present invention improves the situation.

To this end, it proposes a method implemented by computer resources to process a signal by changing between different sub-band domains. The method aims to compact in one and the same processing operation the application of a first vector representing the signal in a first sub-band field to a bank of synthesis filters, then to a bank of analysis filters, to obtain a second vector representing the signal in a second sub-band field.

There is provided in this type of method the application of a matrix filtering to the first vector to directly obtain the second vector.

According to the invention, the synthesis bank and/or the analysis bank are time-varying.

The matrix filtering is represented by a global conversion matrix comprising matrix sub-blocks:
precalculated taking into account the possible variations in time of the filter banks,
and stored in memory,
   and the global conversion matrix is constructed by call to said memory to obtain said sub-blocks precalculated at successive instants.

Advantageously, there are provided a finite number of possible states with which are associated respective sets of coefficients of the synthesis and/or analysis banks, and the abovementioned sub-blocks are precalculated from said respective sets for all the possible states, whereas the global conversion matrix is determined for at least one possible state defined from the properties of the signal to be processed, notably the signal's stationarity properties.

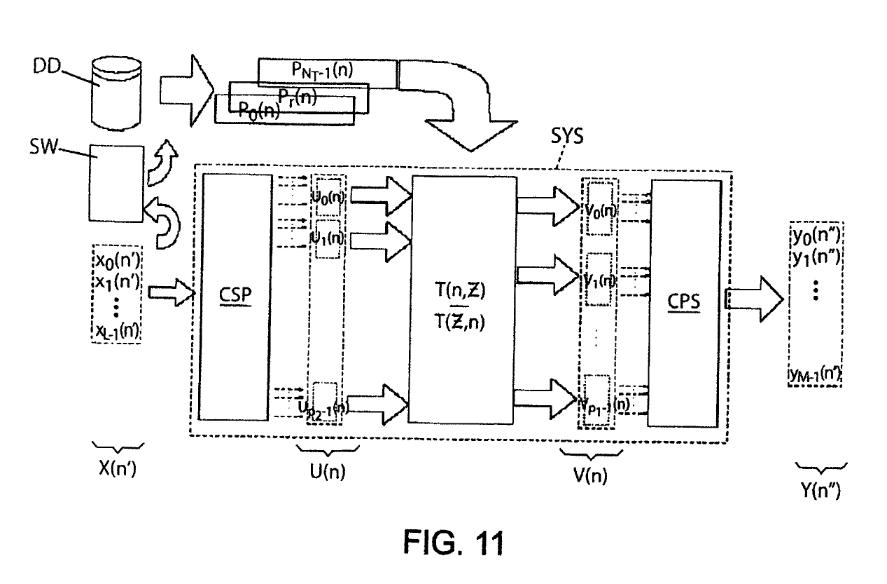

The present invention also aims for a device for processing a signal by changing between different sub-band fields. One example of such a device is illustrated in FIG. 11 which will be described in detail later. To implement the inventive method, it also comprises general computer resources notably including a processor (not represented):
a memory DD storing the precalculated sub-blocks,
a clock HOR for determining the successive instants, and
a matrix filtering module MFM arranged to recover from the memory DD the sub-blocks precalculated for these successive instants, to construct the global conversion matrix.

Advantageously, the device also comprises a switchover control SW for:
defining, from the signal to be processed, one of said possible states and sets of associated coefficients, and
managing access to said memory as a function of the defined state.

Such a device can be incorporated in equipment such as a server, a gateway, or even a terminal, intended for a communication network.

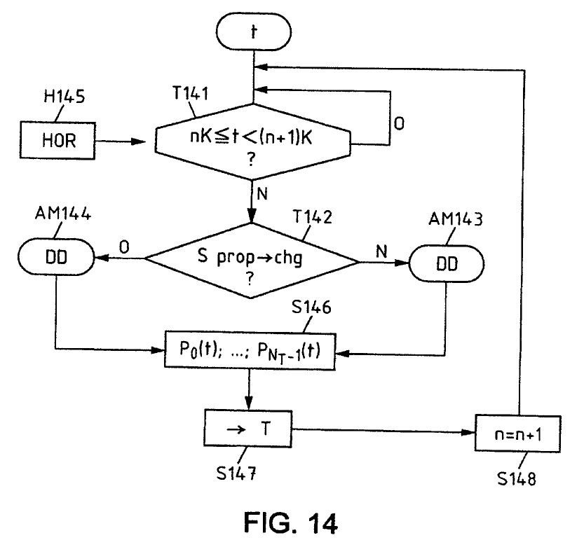

The present invention also aims for a computer program, intended to be stored in a memory of such a device and comprising instructions for implementing the inventive method. One possible algorithm for such a program can be represented very schematically by the flow diagram of FIG. 14 which will be described in detail later.

Other advantages and characteristics of the invention will become apparent from examining the detailed description hereinbelow, given by way of exemplary embodiments, and the appended drawings in which, in addition to the FIGS. 1 and 2 described previously:

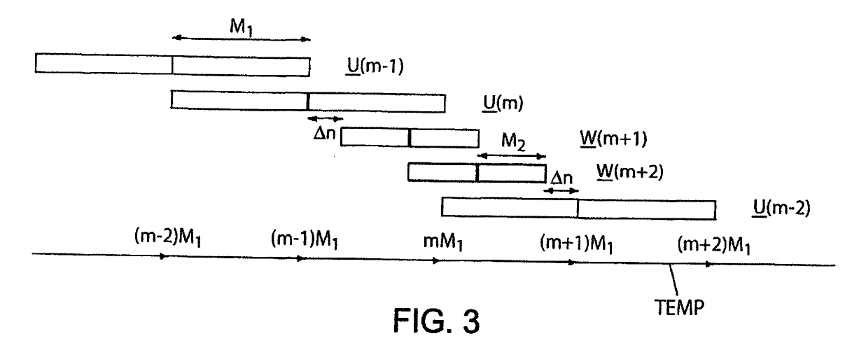

FIG. 3 illustrates the overlaps of successive long and short blocks occurring between two transitions of a TV-MLT transform, in comparison to a time axis TIME;

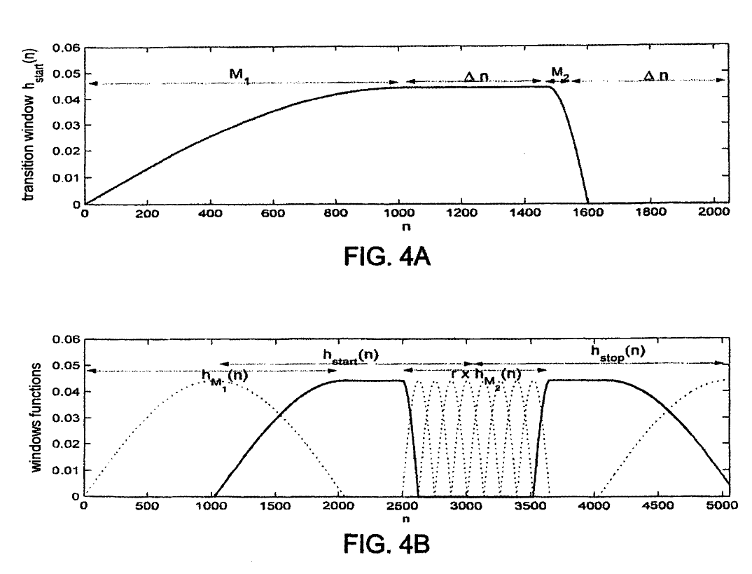

FIG. 4A represents a transition function hₛₜₐᵣₜ(n) of a TV-MLT transform;

FIG. 4B represents the windowing that occurs between two changes of resolution of the TV-MLT transform;

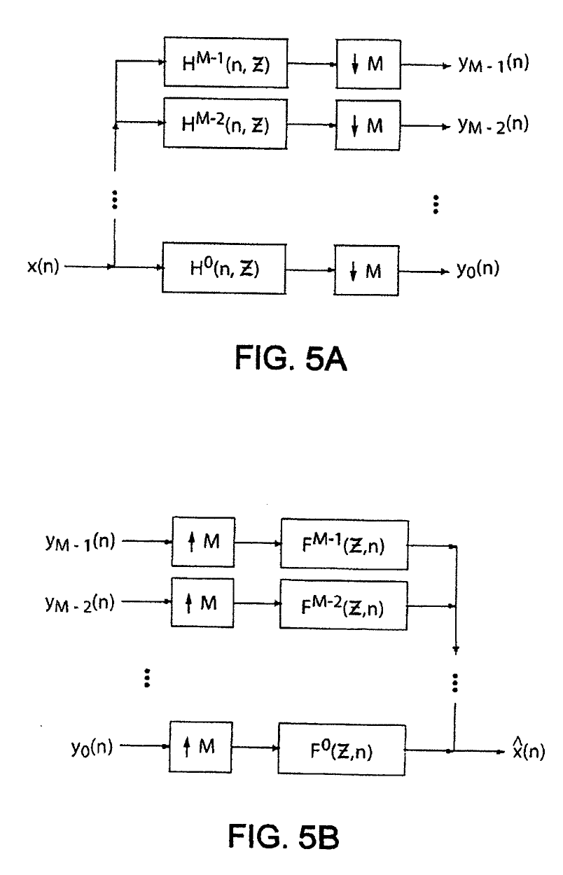

FIG. 5A illustrates a bank of time-varying analysis filters, with maximum decimation;

FIG. 5B illustrates a bank of time-varying synthesis filters, with maximum decimation;

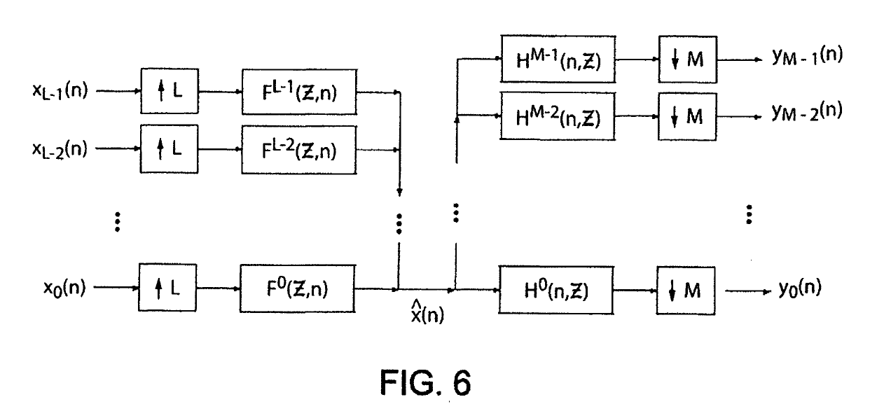

FIG. 6 is a conventional detailed diagram of the conversion between different sub-band fields;

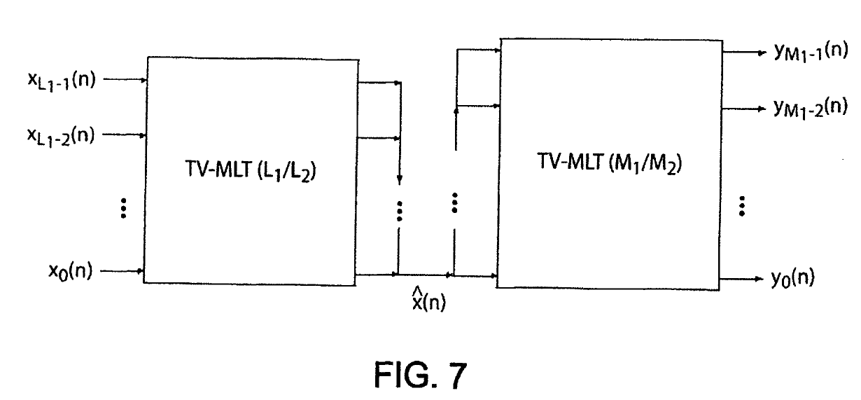

FIG. 7 is a diagram illustrating the conversion between the representations of a signal by two TV-MLT transforms of different sizes, by way of example for a code conversion between the Dolby AC-3 format and the MPEG-2/4 ACC format;

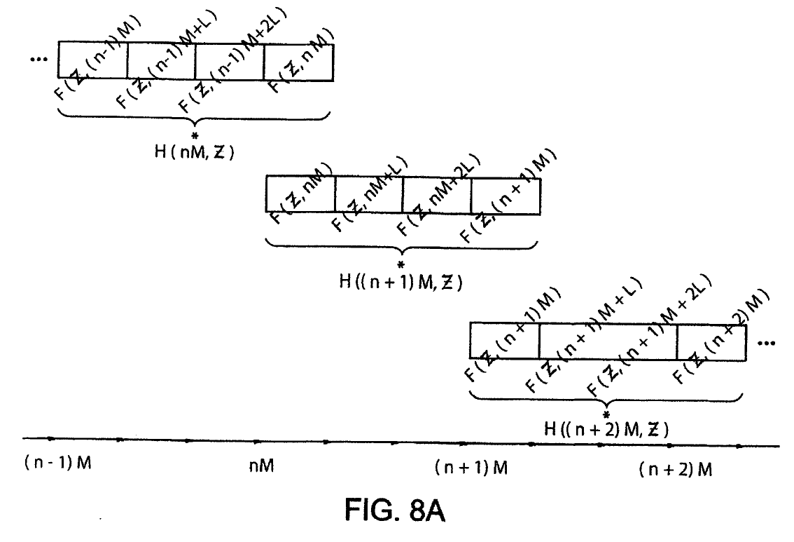

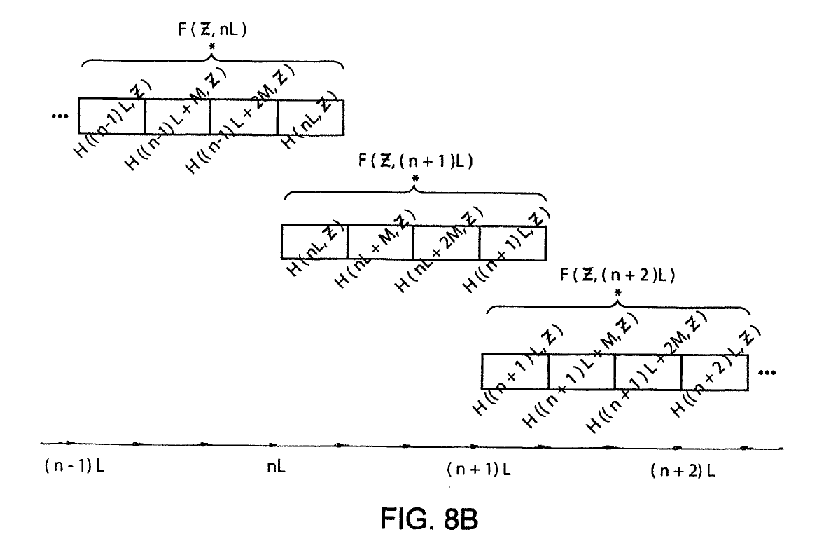

FIG. 8A illustrates an intermediate step of the construction of the states of a conversion submatrix based on a first form, called “form A” hereinbelow;

FIG. 8B illustrates an intermediate step of the construction of the states of a conversion submatrix based on a second form, called “form B” hereinbelow;

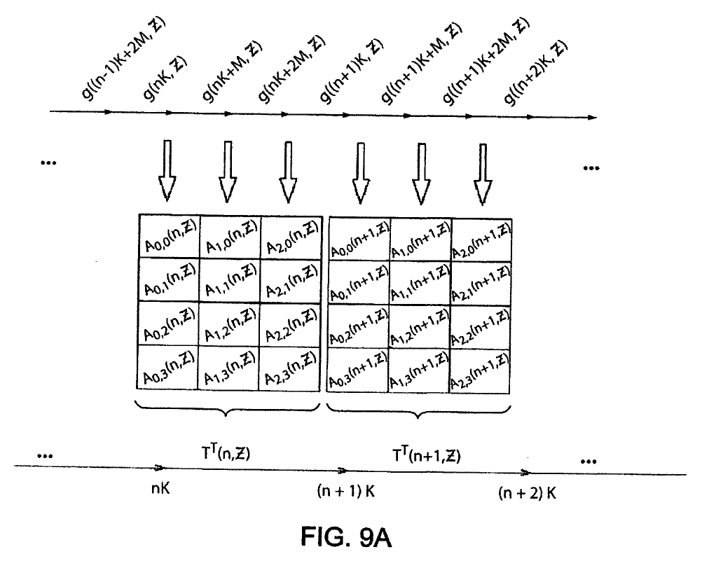

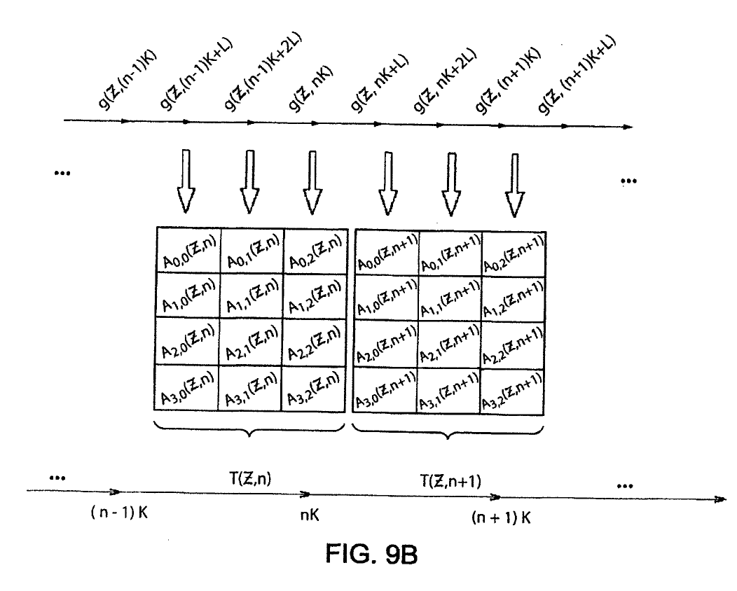

FIG. 9A illustrates the construction of the states of the global conversion matrix T(n,Z) in a general case K=ppcm(L,M) in the form A;

FIG. 9B illustrates the construction of the states of the global conversion matrix T(Z,n) in a general case K=ppcm(L,M) in the form B;

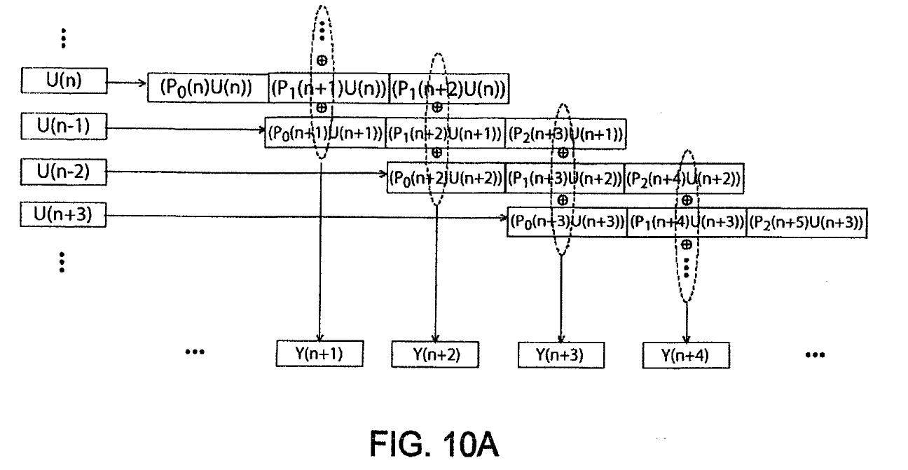

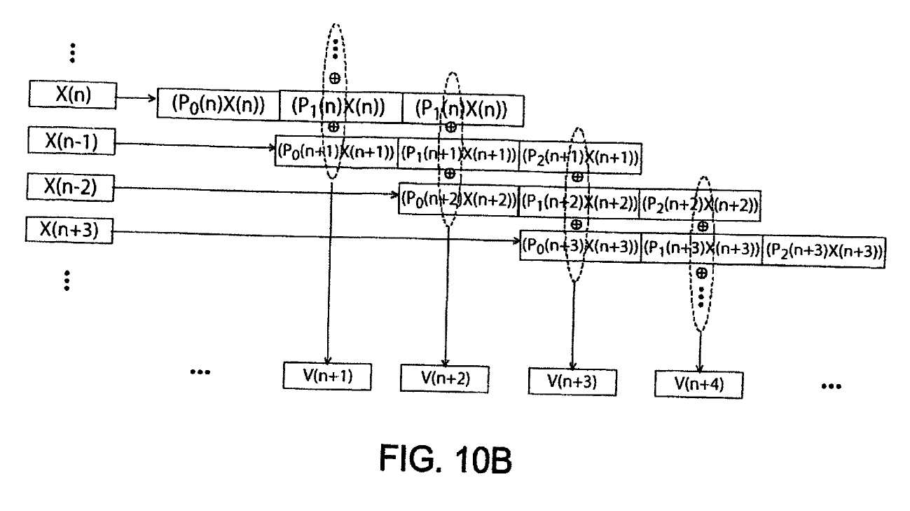

FIG. 10A illustrates an example of global conversion such as a lapped transform in a first particular case where M=pL;

FIG. 10B illustrates an example of global conversion such as a lapped transform in a second particular case where L=pM;

FIG. 11 illustrates an exemplary embodiment of a global conversion system according to the invention;

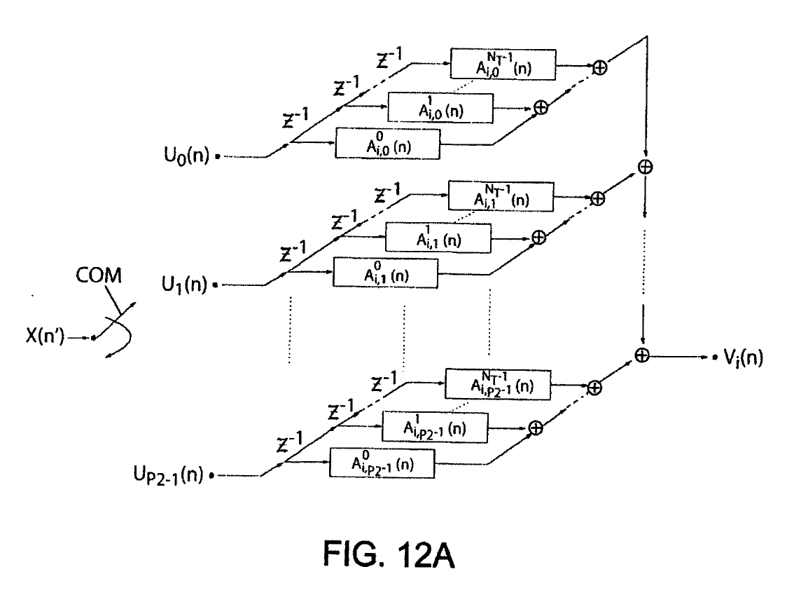

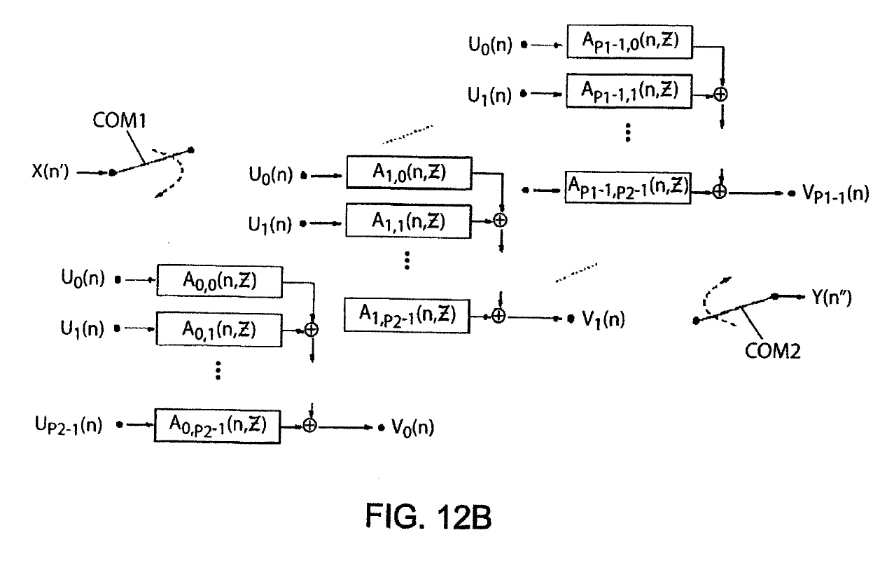

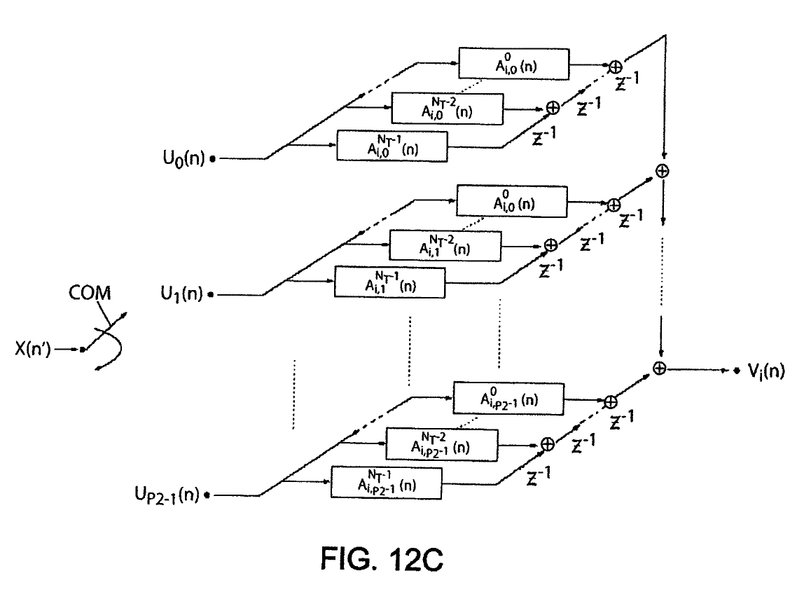

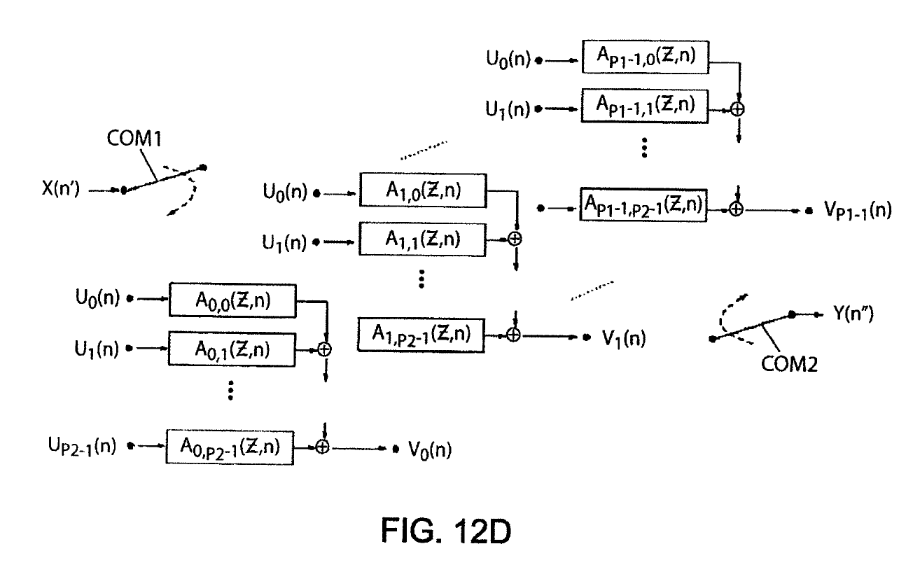

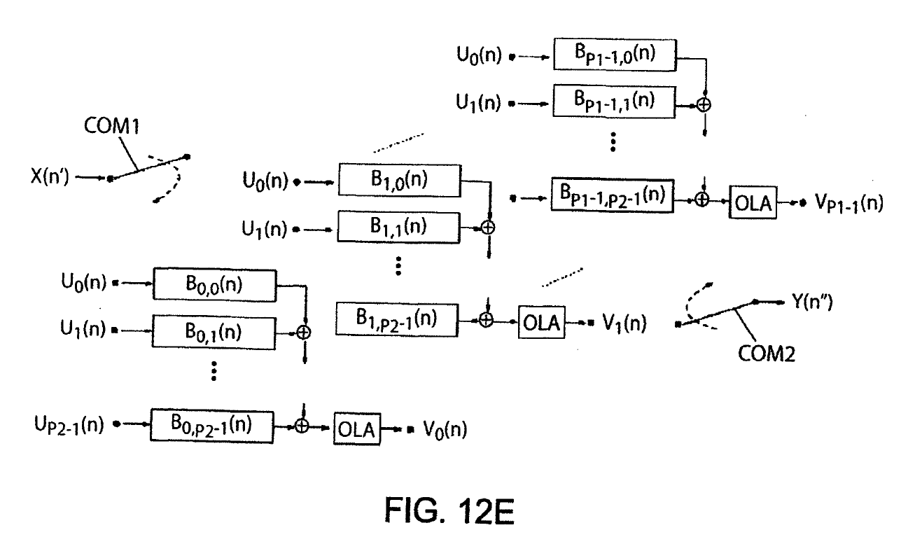

FIG. 12A illustrates the operation of a subsystem of order i of the system of FIG. 11, to deliver a converted polyphase component Vᵢ(n) of an output signal vector, in the manner of a time-varying linear system, for an implementation according to the form A;

FIG. 12B illustrates a representation of the global conversion system, defined in the form A, as a set of time-varying linear subsystems;

FIG. 12C illustrates the operation of a subsystem of order i of the system of FIG. 11, to deliver a converted polyphase component Vᵢ(n) of an output signal vector, in the manner of a time-varying linear system, for an implementation according to the form B;

FIG. 12D illustrates a representation of the global conversion system, defined in the form B, as a set of time-varying linear subsystems;

FIG. 12E illustrates the development of the global conversion system, as time-varying linear system and using the lapped transforms (OLA);

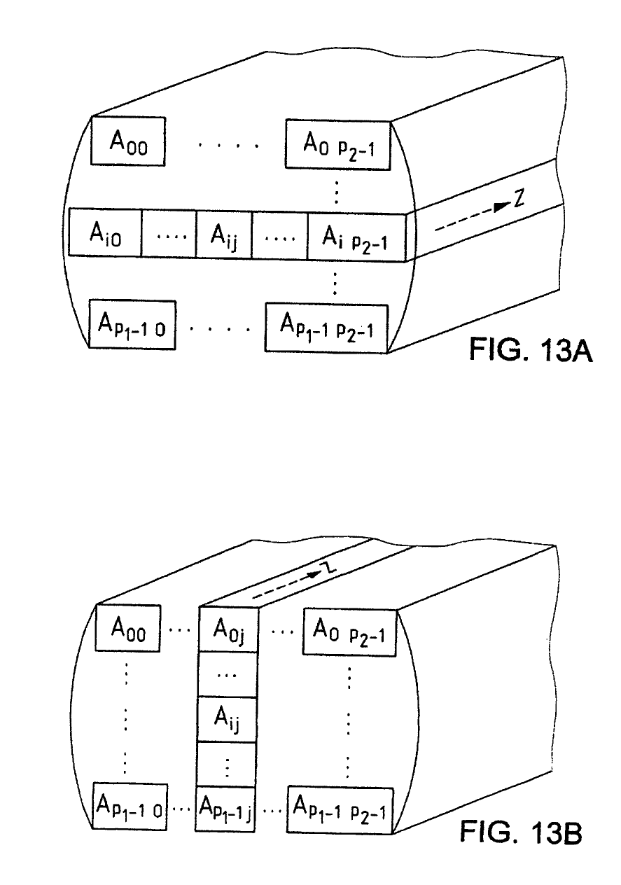

FIGS. 13A and 13B illustrate a three-dimensional global conversion matrix represented by sub-blocks;

FIG. 14 illustrates an exemplary embodiment of the steps of construction of the global conversion matrix.

Before describing in detail one or more embodiments, the choice of the approach proposed by the present invention is justified hereinbelow. Particularly justified hereinbelow is the fact of representing time-varying transforms by filter banks and an equivalence in their representation by filter banks is also demonstrated.

Coders, notably of MPEG-2/4 AAC and Dolby AC-3 type, use time/frequency representations with variable resolution. They work by carrying out time-varying lapped transform analyses, one example of which is the transform of the so-called “TV-MLT” (time-varying modulated lapped transform) type, in which the size of the blocks processed depends on the instantaneous properties of the signal. The time/frequency representation of these coders is called adaptive because the basic functions of the lapped transform vary in time, according to the short-term characteristics of the signal.

The representation of a conventional MLT transform (time-invariant) by a uniform filter bank with perfect reconstruction is known. It will be recalled that an MLT transform is a particular case of analysis/synthesis by cosine modulated filter bank, where the length N of the filters (equivalent to the degree of the filters “plus 1”) is equal to twice the number of sub-bands M (equivalent to the number of filters per bank), or N=2M.

The principle of time-invariant MLT transforms is not described in detail, given that it is widely disclosed in the prior art, notably in:

“Signal Processing with Lapped Transform” by H. S. Malvar, Artech House, Boston, 1992.

The case of a time variation of the conversion is described here, typically following a change of resolution of one of the coders involved in the code conversion.

The coders of MPEG-2/4 AAC and Dolby AC-3 type work with MLT transforms for which the parameter M can take two values which define different sizes of the window function h(n) (M₁ or M₂ according to the table below).

| | MPEG-2/4 AAC | Dolby AC-3 |
|---|---|---|
| Window length 2M₁ | 2048 | 512 |
| Window length 2M₂ | 256 | 256 |
| r = M₁/M₂ | 8 | 2 |
| Δn | 448 | 64 |

Window sizes of MPEG-2/4 AAC and Dolby AC-3 coders.

The change from one window size to the other creates a time variation of the frequency resolution of the transform. Moreover, this change can be applied while retaining the property of perfect reconstruction of the signal. The TV-MLT transforms used by the abovementioned coders thoroughly check this condition. More particularly, the window switching technique defined in the MPEG-2/4 AAC standard uses asymmetrical transition window functions hereinafter denoted hₛₜₐᵣₜ and hₛₜₒₚ, during the resolution change periods.

The operations implemented by the TV-MLT transforms are defined hereinbelow, by following the appearance of the transition windows hₛₜₐᵣₜ and hₛₜₒₚ which guarantee the property of perfect reconstruction.

The lapped transform matrix, P, is broken down as follows:

P=D_{M} [symbol] h_{M}

in which the operator [symbol] is defined as the product component by component and line by line of the matrix elements. D_{M} is the modulation matrix, of size, M×2M, defined by:

$${D}_{M} = ( \begin{matrix}{d}_{0} ( 0 ) & {d}_{0} ( 1 ) & … & {d}_{0} ( 2 M - 1 ) \\ {d}_{1} ( 0 ) & {d}_{1} ( 1 ) & … & {d}_{1} ( 2 M - 1 ) \\ ⋮ & ⋮ & ⋱ & ⋮ \\ {d}_{M - 1} ( 0 ) & {d}_{M - 1} ( 1 ) & … & {d}_{M - 1} ( 2 M - 1 )\end{matrix} ) \qquad ( 1 )$$

with the basic functions such that:

$${d}_{k} ( n ) = \sqrt{\frac{2}{M}} cos [ ( n + \frac{M + 1}{2} ) ( k + \frac{1}{2} ) \frac{π}{M} ] \qquad ( 2 )$$

and k=0, . . . , M−1, n=0, 1, . . . , (2M−1).

h_{M} is used to denote the vector associated with the window function of length 2M, with:

h_{M}=(h_{M}(0)h_{M}(1) . . . h_{M}(2M−1))

Its components h_{M}(n) can be defined, for example, by the sinusoidal function (the most commonly used in audio signal processing applications), of type:

$${h}_{M} ( n ) = sin [ \frac{π}{2 M} ( n + \frac{1}{2} ) ] \qquad ( 3 )$$

h_{M}_{₁} and h_{M}_{₂} are finally used to denote the vectors respectively associated with the window functions of respective lengths M₁ and M₂, and r the ratio such that r=M₁/M₂ (>1).

A polyphase components representation of the input signal x(n) is adopted, such that

u₁(m)=x(mM−1), l=0, . . . , M−1

The block of samples representing a polyphase component of index m is then defined by:

u(m)=(u_{M-1}(m) . . . u₁(m)u₀(m))*,
where the notation x^{T} designate the transpose of the vector x.

To obtain a block of 2M samples, two successive blocks are concatenated, such that:

U(m)=(u(m−1)u(m))* (4)

The transform of the signal block U(m), denoted Y(m), is determined by:

Y(m)=PU(m) (5)

where Y(m)=(y₀(m) y₁(m) . . . y_{M-1}(m))* is the vector of the transform coefficients.

On changing from a long window to a short window, the case of a signal vector U(m) of length 2M₁ is taken, to which is applied a long transition window, denoted hₛₜₐᵣₜ, with the modulation matrix D_{M}_{₁}. The preceding vector U(m−1) is of length 2M₁ to which has been applied normally a standard long window h_{M}_{₁} with the modulation matrix D_{M}_{₁}. On the other hand, the r vectors at the following instants (m+1, m+2, . . . , m+r), denoted W(m+1), W(m+2), . . . , W(m+r), are all of short length 2M₂. Standard short windows h_{M}_{₂} with the modulation matrix D_{M}_{₂} are applied to them.

Then, on a change from a short window to a long window, the signal U(m+2) is of length 2M₁ and a long transition window is applied, denoted hₛₜₒₚ, with the modulation matrix D_{M}_{₁}.

The components of the vectors that occur during the two successive changes of window size are expressed:

$$\begin{matrix}\underline{U} ( m ) = ( x ( ( m - 2 ) {M}_{1} + 1 ) … x ( {mM}_{1} ) ) \\ \underline{W} ( m + 1 ) = ( \begin{matrix}x ( ( m - 1 ) {M}_{1} + Δ n + 1 ) … \\ x ( ( m - 1 ) {M}_{1} + Δ n + 2 {M}_{2} )\end{matrix} ) \\ ⋮ = ⋮ \\ \underline{W} ( m + r ) = ( \begin{matrix}x ( ( m - 1 ) {M}_{1} + Δ n + ( r - 1 ) {M}_{2} + 1 ) … \\ x ( ( m - 1 ) {M}_{1} + Δ n + ( r + 1 ) {M}_{2} )\end{matrix} ) \\ \underline{U} ( m + 2 ) = ( x ( {mM}_{1} + 1 ) … x ( ( m + 2 ) {M}_{1} ) )\end{matrix}$$

The parameter Δn is set at the value Δn=(M₁−M₂)/2. The arrangements of these vectors are illustrated in FIG. 3 for the case where M₁/M₂=2. FIG. 3 illustrates in particular a long window to short window transition at the instant mM₁, and a short window to long window transition at the instant (m+1)M₁. The time axis carries the reference TIME. An overlap can be seen between the long vector U(m) and the following short vectors W(m+1), W(m+2). This overlap is the same as that between the short vectors and the first subsequent long vector U(m+2).

In these conditions, it has been shown that the property of perfect reconstruction of the TV-MLT transform depends only, as for the case of a conventional MLT transform, on the window functions used and, in particular, on the two transition windows hₛₜₐᵣₜ and hₛₜₒₚ of length 2M₁. The condition of perfect reconstruction is verified during the transition periods if these transition windows are those defined according to the four conditions hereinbelow, assuming that the dimension of the transform changes at the instant mM₁ from M₁ to M₂, then at the instant (m+1)M₁ from M₂ to M₁.

First condition: the window function, for a transform of size M₁, is such that:

$${h}_{{M}_{1}} ( n ) = sin [ \frac{π}{2 {M}_{1}} ( n + \frac{1}{2} ) ] \qquad 0 \leq n \leq 2 {M}_{1} - 1$$

Second condition: the window function that occurs at the transition from M₁ to M₂ is such that:

$${h}_{start} ( n ) = \{ \begin{matrix}sin [ \frac{π}{2 {M}_{1}} ( n + \frac{1}{2} ) ] & 0 \leq n \leq {M}_{1} - 1 \\ 1 & {M}_{1} \leq n \leq {M}_{1} + Δ n - 1 \\ sin [ \frac{π}{2 {M}_{2}} ( n - Δ n - {M}_{2} + \frac{1}{2} ) ] & {M}_{1} + Δ n \leq n \leq {M}_{1} + {M}_{2} + Δ n - 1 \\ 0 & {M}_{1} + {M}_{2} + Δ n \leq n \leq 2 {M}_{1} - 1\end{matrix}$$

Third condition: the window function, for a transform of size M₂, is such that:

$${h}_{{M}_{2}} ( n ) = sin [ \frac{π}{2 {M}_{2}} ( n + \frac{1}{2} ) ] \qquad 0 \leq n \leq 2 {M}_{2} - 1$$

Fourth condition: the window function that occurs at the transition from M₂ to M₁ is such that:

$${h}_{stop} ( n ) = \{ \begin{matrix}0 & 0 \leq n \leq Δ n - 1 \\ sin [ \frac{π}{2 {M}_{2}} ( n - Δ n - {M}_{2} + \frac{1}{2} ) ] & Δ n \leq n \leq {M}_{2} + Δ n - 1 \\ 1 & {M}_{2} + Δ n \leq n \leq {M}_{1} - 1 \\ sin [ \frac{π}{2 {M}_{1}} ( n + \frac{1}{2} ) ] & {M}_{1} \leq n \leq 2 {M}_{1} - 1\end{matrix}$$

For the third condition, there are r successive MLT transforms of dimension M₂ between two transition periods. The first transform begins at the instant (m−1)M₁+Δn. The last transform ends at the instant mM₁+M₂+Δn.

FIG. 4A illustrates the appearance of the transition function hₛₜₐᵣₜ(n) that occurs during a change of dimension from M₁ to M₂ defined by the four conditions hereinabove ensuring a perfect reconstruction. It will be noted that reciprocal transition window hₛₜₒₚ(n) occurring during a transition from M₂ to M₁ is simply such that:

hₛₜₒₚ(n)=hₛₜₐᵣₜ(2M₁−1−n)

FIG. 4B represents the succession of the transition windows that occur during the two time resolution change periods of the TV-MLT transform. More particularly, FIG. 4B illustrates the windowing that occurs during the two changes of resolution from M₁ to M₂, then from M₂ to M₁, with, in the example represented, M₁=1024 and M₂=128.

In practice, several changes of resolution of the transform can then be considered. These changes of resolution occur at instants that are multiples of M₁ and are initiated according to the properties of the incoming signal, notably stationarity. This property is known to coders with dynamic change of resolution.

In particular, with reference to FIG. 4B, equivalents of MLT transforms can be seen:
over a long window for the instants n between 0 and 2047, hereinafter called “first region”,
over a first transition window to ensure a perfect reconstruction, for the instants n between 1024 and 2623, hereinafter called “second region”,
over a succession of a plurality of short windows (r windows h_{M}_{₂} of size M₂), for the instants n between 2496 and 3647, hereinafter called “third region”, and
over a second transition window to ensure a perfect reconstruction towards a return to a long window, for the instants n between 3520 and 5119, hereinafter called “fourth region”.

The observation of the windowing over the transition, comprising in particular the third region with the succession of short windows, is important to the rest of the description.

The global TV-MLT transform can be defined completely by a global conversion matrix, of “infinite” dimension, denoted T(m) and such that:

$$T ( m ) = \\ [ \begin{matrix}⋱ & & & & & & \\ & {P}_{0} ( m - 1 ) & {P}_{1} ( m - 1 ) & & & & \\ & & {P}_{0} ( m ) & {P}_{1} ( m ) & & & \\ & & & {P}_{0} ( m + 1 ) & {P}_{1} ( m + 1 ) & & \\ & & & & {P}_{0} ( m + 2 ) & {P}_{1} ( m + 2 ) & \\ & & & & & & ⋱\end{matrix} ] \qquad ( 6 )$$

where P₀(m) and P₁(m) are submatrices of size M×M defined with the indices of block m of which corresponds to the instant mM₁.

In particular, the concatenation P(m)=[P₀(m)P₁(m)] of size M₁×2M₁ represents the lapped transform matrix, the expressions of which are given hereinbelow for any instant mM₁.

The condition of perfect reconstruction that the TV-MLT transform provides is governed by the equality:

T*(m)T(m)=I

By using the formulation (6) of the transform matrix, the condition of perfect reconstruction is defined equivalently simply by the following three equalities:

P₀*(m)P₀(m)+P₁*(m−1)P₁(m−1)=I

P₁*(m)P₁(m)+P₀*(m+1)P₀(m+1)=I

P₀*(m)P₁(m)=0 (7)

The condition of perfect reconstruction (7) means that the lapped transform matrix P(m) remains orthogonal to the two adjacent matrices P(m−1) and P(m+1). By applying again the four conditions given above, with the succession of changes of size of the transform, the lapped transform matrices are then defined by:

P(m−1)=D_{M}_{₁} [symbol] h_{M}_{₁}P(m)=D_{M}_{₁} [symbol] hₛₜₐᵣₜP(m+2)=D_{M}_{₁} [symbol] hₛₜₒₚ (8)
where hₛₜₐᵣₜ=(hₛₜₐᵣₜ(0) . . . hₛₜₐᵣₜ(2M₁)) and hₛₜₒₚ=(hₛₜₒₚ(0) . . . hₛₜₒₚ(2M₁)).

The finite lapped transform matrix associated with the block m+1 which corresponds to r successive MLT transforms of size M₂ (“third region” of FIG. 4B) is defined by:

$$[ \underbrace{\begin{matrix}0 & … & 0 \\ & ⋮ & \\ & & \\ 0 & … & 0\end{matrix}}_{{0}_{{M}_{1} \times Δ n}} \begin{matrix}{P}_{0}^{{M}_{2}} & {P}_{1}^{{M}_{2}} & 0 & … & 0 \\ 0 & {P}_{0}^{{M}_{2}} & {P}_{1}^{{M}_{2}} & & ⋮ \\ ⋮ & & ⋱ & ⋱ & 0 \\ 0 & … & 0 & {P}_{0}^{{M}_{2}} & {P}_{1}^{{M}_{2}}\end{matrix} \underbrace{\begin{matrix}0 & … & 0 \\ & ⋮ & \\ & & \\ 0 & … & 0\end{matrix}}_{{0}_{{M}_{1} \times Δ n}} ] \qquad ( 9 )$$

where P₀^{M}^{₂} and P₁^{M}^{₂} are the lapped transform matrices of the MLT transform of size M₂×2M₂ and which is also broken down into a form of the type [P₀^{M}^{₂}P₁^{M}^{₂}]=D_{M}_{₂} [symbol] h_{M}_{₂}.

It can thus be shown that there are four possible situations (four regions of FIG. 4B) defined by four possible values of the matrix P(m). It will already be understood that the lapped transform matrix P(m) allows four possible “states”.

Hereinafter, the expression of the matrix P(m+1) given hereinabove, corresponding to one of the four allowable states, will be denoted Q_{M}_{₂} to qualify generally this state among the four allowable states.

Starting from the definitions of the possible lapped matrices P(m), it is shown that the conditions of perfect reconstruction (7) are satisfied when the window functions of the prototype filters hₛₜₐᵣₜ and hₛₜₒₚ are those defined by the four conditions hereinabove.

The direct transformation operation of the TV-MLT transform is then defined by:

Y(m)=P(m)U(m) (10)

where Y(m) is the vector of the transform coefficients at the instant mM₁ and U(m) is a vector defined from the input vector by the relation (3) hereinabove.

The reverse transformation operation is defined, as for the invariant case of the MLT transform, by two steps:
reverse transformation of the vectors of the transform coefficients:

Z(m)=P(m)*Y(m) (11)
addition with overlap (or OLA for “overlap and add”) of the vectors obtained

û(m)=z₀(m)+z₁(m−1) (12)
where the following notations are used:
z₀(m) and z₁(m) to represent the blocks of size M₁ that make up the vector Z(m), such that Z(m)=(z₀(m) z₁(m)), and
û(m) to represent the reconstructed vector, assumed to have the value of the initial vector u(m) because the reconstruction is perfect.

There now follows a description of the bases of a representation of a TV-MLT transform by filter banks.

The TV-MLT transform presented hereinabove makes it possible to change from an MLT transform of size M₁ to an MLT transform of size M₂ (or conversely from M₂ to M₁), while retaining the property of perfect reconstruction of the signal. It has thus been shown how to process direct and reverse transformations of the TV-MLT transformation on vector blocks of the same constant size 2M₁.

Assuming the case of the transformation of the vector U(m+1) by the lapped transform matrix given by the relation (9) hereinabove (third region of FIG. 4B), the vector Y(m+1) of size M₁, such that:

Y(m+1)=P(m+1)U(m+1)

is defined, by construction, as being the concatenation of the r subsequent transformed vectors, all of size M₂:

D_{M}_{₂} [symbol] h_{M}_{₂}W(m+1), D_{M}_{₂} [symbol] h_{M}_{₂}W(m+2), . . . , D_{M}_{₂} [symbol] h_{M}_{₂}W(m+r).

It will be recalled that this construction evolves from the observation of FIG. 4B, the importance of which is stressed hereinabove.

The lapped transform matrix of the block (m+1) is constructed so as to respect the time offset Δn (FIG. 3).

In the context of the modeling of the system of conversion between different sub-band fields, it is advantageous to have a TV-MLT transform implementation architecture which leads to analysis/synthesis operations of constant dimension. There is proposed hereinbelow a filter bank architecture with maximum time-varying decimation defined as follows.

The TV-MLT transformation used notably by the MPEG-2/4 AAC or Dolby AC-3 standardized coders and described previously allows a filter bank representation with maximum time-varying decimation. The length of the filters is equal to twice the number M, of sub-bands. The equivalent bank of analysis (respectively synthesis) filters is described by the diagram of FIG. 5A (respectively of FIG. 5B) and the representations in the field of the variable Z of the filters H⁰(n,Z), . . . , H^{M}^{₁}⁻¹(n,Z) (respectively F⁰(Z,n), . . . , F^{M}^{₁}⁻¹(Z,n)) at the instants mM₁ are defined as follows.

Over a period with time resolution M₁, the coefficients of the impulse responses h₀^{k}(mM₁), . . . , h_{2M}_{₁}₋₁^{k}(mM₁) and f₀^{k}(mM₁), . . . , f_{2M}_{₁}₋₁^{k}(mM₁), with k=0, . . . , M₁−1, are given by the relations (13) and (14):

$$\begin{matrix}( \begin{matrix}{h}_{2 {M}_{1} - 1}^{0} ( {mM}_{1} ) & … & {h}_{0}^{0} ( {mM}_{1} ) \\ {h}_{2 {M}_{1} - 1}^{1} ( {mM}_{1} ) & … & {h}_{0}^{1} ( {mM}_{1} ) \\ ⋮ & & ⋮ \\ {h}_{2 {M}_{1} - 1}^{{M}_{1} - 1} ( {mM}_{1} ) & … & {h}_{0}^{{M}_{1} - 1} ( {mM}_{1} )\end{matrix} ) = {D}_{{M}_{1}} ⊗ {h}_{{M}_{1}} ; & ( 13 ) \\ ( \begin{matrix}{f}_{0}^{0} ( {mM}_{1} ) & … & {f}_{2 {M}_{1} - 1}^{0} ( {mM}_{1} ) \\ {f}_{0}^{1} ( {mM}_{1} ) & … & {f}_{2 {M}_{1} - 1}^{1} ( {mM}_{1} ) \\ ⋮ & & ⋮ \\ {f}_{0}^{{M}_{1} - 1} ( {mM}_{1} ) & … & {f}_{2 {M}_{1} - 1}^{{M}_{1} - 1} ( {mM}_{1} )\end{matrix} ) = {D}_{{M}_{1}} ⊗ {h}_{{M}_{1}} & ( 14 )\end{matrix}$$

This is a first possible state corresponding to the situation of the first region of FIG. 4B.

During a period with time resolution M₂, the coefficients of the impulse responses h₀^{k}(mM₁), . . . , h_{2M}_{₁}₋₁^{k}(mM₁) and f₀^{k}(mM₁), . . . , f_{2M}_{₁}₋₁^{k}(mM₁), with k=0, . . . , M₁−1, are given by the relations (15) and (16):

$$\begin{matrix}( \begin{matrix}{h}_{2 {M}_{1} - 1}^{0} ( {mM}_{1} ) & … & {h}_{0}^{0} ( {mM}_{1} ) \\ {h}_{2 {M}_{1} - 1}^{1} ( {mM}_{1} ) & … & {h}_{0}^{1} ( {mM}_{1} ) \\ ⋮ & & ⋮ \\ {h}_{2 {M}_{1} - 1}^{{M}_{1} - 1} ( {mM}_{1} ) & … & {h}_{0}^{{M}_{1} - 1} ( {mM}_{1} )\end{matrix} ) = {Q}_{{M}_{2}} ; & ( 15 ) \\ \begin{matrix}( \begin{matrix}{f}_{0}^{0} ( {mM}_{1} ) & … & {f}_{2 {M}_{1} - 1}^{0} ( {mM}_{1} ) \\ {f}_{0}^{1} ( {mM}_{1} ) & … & {f}_{2 {M}_{1} - 1}^{1} ( {mM}_{1} ) \\ ⋮ & & ⋮ \\ {f}_{0}^{{M}_{1} - 1} ( {mM}_{1} ) & … & {f}_{2 {M}_{1} - 1}^{{M}_{1} - 1} ( {mM}_{1} )\end{matrix} ) = {Q}_{{M}_{2}} & \end{matrix} & ( 16 )\end{matrix}$$

This is a second possible state corresponding to the situation of the third region of FIG. 4B.

During a transition period changing from a resolution M₁ to M₂, the coefficients of the impulse responses h₀^{k}(mM₁), . . . , h_{2M}_{₁}₋₁^{k}(mM₁) and f₀^{k}(mM₁), . . . , f_{2M}_{₁}₋₁^{k}(mM₁), with k=0, . . . , M₁₋1, are given by the relations (17) and (18):

$$\begin{matrix}( \begin{matrix}{h}_{2 {M}_{1} - 1}^{0} ( {mM}_{1} ) & … & {h}_{0}^{0} ( {mM}_{1} ) \\ {h}_{2 {M}_{1}}^{1} ( {mM}_{1} ) & … & {h}_{0}^{1} ( {mM}_{1} ) \\ ⋮ & & ⋮ \\ {h}_{2 {M}_{1} - 1}^{{M}_{1} - 1} ( {mM}_{1} ) & … & {h}_{0}^{{M}_{1} - 1} ( {mM}_{1} )\end{matrix} ) = {D}_{{M}_{1}} ⊗ {h}_{start} ; & ( 17 ) \\ ( \begin{matrix}{f}_{0}^{0} ( {mM}_{1} ) & … & {f}_{2 {M}_{1} - 1}^{0} ( {mM}_{1} ) \\ {f}_{0}^{1} ( {mM}_{1} ) & … & {f}_{2 {M}_{1} - 1}^{1} ( {mM}_{1} ) \\ ⋮ & & ⋮ \\ {f}_{0}^{{M}_{1} - 1} ( {mM}_{1} ) & … & {f}_{2 {M}_{1} - 1}^{{M}_{1} - 1} ( {mM}_{1} )\end{matrix} ) = {D}_{{M}_{1}} ⊗ {h}_{start} & ( 18 )\end{matrix}$$

This is a third possible state corresponding to the situation of the second region in FIG. 4B.

During a transition period changing from a resolution M₂ to M₁, the coefficients of the impulse responses h₀^{k}(mM₁), . . . , h_{2M}_{₁}₋₁(mM₁) and f₀^{k}(mM₁), . . . , f_{2M}_{₁}₋₁(mM₁), with k=0, . . . , M₁−1, are given by the relations (19) and (20):

$$\begin{matrix}( \begin{matrix}{h}_{2 {M}_{1} - 1}^{0} ( {mM}_{1} ) & … & {h}_{0}^{0} ( {mM}_{1} ) \\ {h}_{2 {M}_{1} - 1}^{1} ( {mM}_{1} ) & … & {h}_{0}^{1} ( {mM}_{1} ) \\ ⋮ & & ⋮ \\ {h}_{2 {M}_{1} - 1}^{{M}_{1} - 1} ( {mM}_{1} ) & … & {h}_{0}^{{M}_{1} - 1} ( {mM}_{1} )\end{matrix} ) = {D}_{{M}_{1}} ⊗ {h}_{stop} ; & ( 19 ) \\ ( \begin{matrix}{f}_{0}^{0} ( {mM}_{1} ) & … & {f}_{2 {M}_{1} - 1}^{0} ( {mM}_{1} ) \\ {f}_{0}^{1} ( {mM}_{1} ) & … & {f}_{2 {M}_{1} - 1}^{1} ( {mM}_{1} ) \\ ⋮ & & ⋮ \\ {f}_{0}^{{M}_{1} - 1} ( {mM}_{1} ) & … & {f}_{2 {M}_{1} - 1}^{{M}_{1} - 1} ( {mM}_{1} )\end{matrix} ) = {D}_{{M}_{1}} ⊗ {h}_{stop} & ( 20 )\end{matrix}$$

This is finally a fourth possible state corresponding to the situation of the fourth region of FIG. 4B.

The results hereinabove will be useful for what follows, in the sense that the terms defining the filters h₀^{k}(mM₁), . . . , h_{2M}_{₁}₋₁^{k}(mM₁) and f₀^{k}(mM₁), . . . , f_{2M}_{₁}₋₁^{k}(mM₁) are ultimately determined directly from the modulation matrix D, known and expressed by the relation (1), on the one hand, and from the windows h defined by the four conditions hereinabove to satisfy the perfect reconstruction, on the other hand.

The bank of analysis/synthesis filters defined in this way then has perfect reconstruction. Such is the basis of the representation of the TV-MLT transform by filter banks. Here, only the coefficients of the filters vary in time, the number of sub-bands remaining fixed.

It will then be recalled, in general terms, that each set of coefficients of the analysis or synthesis bank, associated with a possible state, can be calculated as a function of a modulation matrix D and of a vector h characterizing this possible state and ensuring a property of perfect reconstruction, (as in the example described hereinabove) or even “almost-perfect”. The expression “almost perfect” reconstruction will be understood to mean the property of reconstruction of the filter banks used in coders of MPEG-1/2 layer 1 & 2 type in particular. It will then be understood that, in the case, for example, of a combination of a coder of this type with a time-varying coder, the properties described hereinabove can again be observed.

One prejudice of the state of the art, whereby it was not possible to represent a time-varying transform by filter banks, has thus been overcome. Here, it has been demonstrated that a TV-MLT transform was perfectly equivalent to a filter-bank representation with a fixed number of sub-bands, maximum, corresponding to the state where the weighting window is long, and this, regardless of the state of the TV-MLT transform. This embodiment then makes it possible to anticipate all the possible changes of state of the TV-MLT transform.

In particular, the equivalence of the representation of the TV-MLT time-varying lapped transforms by a bank of FIR (finite impulse response) filters and with maximum time-varying decimation, has been shown. Time-varying systems, commonly used, notably by the MPEG-2/4 AAC and Dolby AC-3 coders, can then implement adaptive sub-band representations, which can be defined, as described hereinabove, by the formalism of the time-varying linear systems.

Details on the formalism of the time-varying linear systems are notably described in:

“Time-Varying Filters and Filter Banks: Some Basic Principles”, S Phoong and P. P. Vaidyanathan, IEEE Transactions on Signal Processing, volume 44, No. 12, pages 2971-2987 (December 1996), and
“Factorizability of lossless time-varying filters and filter banks”, S Phoong and P. P. Vaidyanathan, IEEE Transactions on Signal Processing, volume 45, No. 8, pages 1971-1986 (August 1997).

There now follows a description of the conversion technique according to the invention, taking into account particular cases of code conversion, and control of the algorithmic delay induced by the conversion according to the invention.

As indicated previously, conversions are described in which the time/frequency representations vary in time.

FIG. 6 shows the representation in multi-rate blocks to illustrate the conversion.

Signal vectors in sub-bands X(n)=[x₀(n), . . . , x_{L-1}(n)]* are transmitted as input to a bank of synthesis filters F⁰(Z,n), . . . , F^{L-1}(Z,n) comprising L channels, after having undergone an expansion (oversampling by a factor L). The synthesized signal \hat{x}(n) is analyzed by the filter bank H⁰(n,Z), . . . , H^{M-1}(n,Z) comprising M channels and there is obtained at the output, following the application of a decimation (undersampling by a factor M), new signals in sub-bands Y(n)=[y₀(n), . . . , y_{M-1}(n)]. It will then be understood that the number of channels L and M remain constant but the values of the coefficients of the filters change notably according to the windowing (long windows, short windows, transition windows, according to the observation of FIG. 4B). In FIG. 6, the notation ↑L corresponds to an oversampling (or expansion) by a factor L, whereas the notation ↓M corresponds to an undersampling (or decimation) by a factor M.

An effort is then made to merge in a single step the application of the two synthesis/analysis filter banks to reduce the algorithmic complexity (number of calculation operations and memory required).

The techniques of conversion between representations of the signal in different sub-band fields are used to perform code conversions notably between the coders:
according to the MPEG-1/2 standard (layer I and II),
and/or MPEG-2/4 AAC,
and/or of Dolby AC-3 type, and
and/or even according to the G.722.1 standard (for example, the so-called “TDAC” (Time Domain Aliasing Cancellation) coder).

The time/frequency representations of the signal used by these coders are specified in the standards and are such that:
for MPEG-1/2 layer 1 and layer 2, a representation of the signal in sub-bands is used, based on the analysis/synthesis by filter banks of pseudo-QMF (Quadrature Mirror Filter) type, comprising 32 channels,
for MPEG-2/4 AAC, representations in sub-bands with variable resolution and analyses by time-varying lapped transforms TV-MLT are used, where the length of the transformed blocks 2M depends on the properties of the signal being processed,
for Dolby AC-3, a representation of the signal by time-varying lapped transform TV-MLT is used with M=256 or M=128,
for G 722.1 (TDAC), a representation by TDAC filter banks comprising 320 sub-bands is used.

In these conditions, the G 722.1 coder and the MPEG-1/2 (layer 1 and 2) coders use representations by time-invariant filter banks. Moreover, it has been stressed hereinabove that the TV-MLT transforms of the MPEG-2/4 AAC and AC3 coders allow a representation in the form of a filter bank with maximum decimation and with a fixed number M of sub-bands, with time-varying filters.

It is then proposed to define hereinbelow the analysis filters H^{k}(n,Z) and synthesis filters F^{k}(Z,n) for all the types of coders cited. Thus, FIG. 6 formally represents all the possible conversion cases between the different coder examples cited.

The following notations are used:
H(n,Z)=[H⁰(n,Z), . . . , H^{M-1}(n,Z)]* to represent the column vector combining the M time-varying analysis filters, and
F(Z,n)=[F⁰(Z,n), . . . , F^{L-1}(Z,n)] is used to represent the row vector combining the L time-varying synthesis filters.

Definition of the Expression According to the Form A

The corresponding representations in the field Z can be denoted:

$$\begin{matrix}{H}^{k} ( n , Z ) = {\sum }_{i = 0}^{{N}_{h} - 1} {h}_{i}^{k} ( n ) {Z}^{- i} & {F}^{k} ( Z , n ) = {\sum }_{j = 0}^{{N}_{f} - 1} {Z}^{- j} {f}_{j}^{k} ( n )\end{matrix} \qquad ( 21 )$$

where the respective lengths of the filters Nₕ (analysis) and N_{f} (synthesis) are constant.

The vector of the signals in sub-bands, Y(n), at the output of the bank of analysis filters, is expressed:

$$\begin{matrix}Y ( n ) = [ H ( n , Z ) F ( Z , n ) [ X ( n ) ] {\vert}_{↑ L} ] {\vert}_{↓ M} \\ = [ g ( n , Z ) [ X ( n ) ] {\vert}_{↑ L} ] {\vert}_{↓ M}\end{matrix} \qquad ( 22 )$$

where the matrix operator g(n,Z)=H(n,Z)F(Z,n) is defined by its representation in the field Z of a form called hereinbelow “form A” such that its elements are defined by:

$$\begin{matrix}{( g ( n , Z ) )}_{{k}_{1} , {k}_{2}} = {H}^{{k}_{1}} ( n , Z ) {F}^{{k}_{2}} ( Z , n ) \\ = {\sum }_{i = 0}^{{N}_{h} - 1} {\sum }_{j = 0}^{{N}_{f} - 1} {h}_{i}^{{k}_{1}} ( n ) {f}_{j}^{{k}_{2}} ( n - i - j ) {Z}^{- ( i + j )} \\ = {\sum }_{i = 0}^{{N}_{h} + {N}_{f} - 1} {g}_{i}^{{k}_{1} , {k}_{2}} ( n ) {Z}^{- i}\end{matrix} \qquad ( 23 )$$

with k₁=0, . . . , (M−1) and k₂=0, . . . , (L−1). Its coefficients gᵢ^{k}^{₁}^{k}^{₂}(n) are defined by:

$${g}_{i}^{{k}_{1} , {k}_{2}} ( n ) = {\sum }_{j} {h}_{j}^{{k}_{1}} ( n ) {f}_{i - j}^{{k}_{2}} ( n - i ) \qquad ( 24 )$$

Definition of the Expression According to the Form B

The operator g(n,Z)=H(n,Z)F(Z,n) can also be defined in another form, hereinafter called “form B”, as follows:

$$\begin{matrix}{( g ( Z , n ) )}_{{k}_{1} , {k}_{2}} = {H}^{{k}_{1}} ( n , Z ) {F}^{{k}_{2}} ( Z , n ) \\ = {\sum }_{i = 0}^{{N}_{h} - 1} {\sum }_{j = 0}^{{N}_{f} - 1} {Z}^{- ( i + j )} {h}_{i}^{{k}_{1}} ( n + i + j ) {f}_{j}^{{k}_{2}} ( n ) \\ = {\sum }_{i = 0}^{{N}_{h} + {N}_{f} - 1} {Z}^{- i} {g}_{i}^{{k}_{1} , {k}_{2}} ( n )\end{matrix} \qquad ( 25 )$$

with k₁=0, . . . , (M−1) and k₂=0, . . . , (L−1) and the coefficients gᵢ^{k}^{₁}^{k}^{₂}(n) being defined by:

$${g}_{i}^{{k}_{1} , {k}_{2}} ( n ) = {\sum }_{j} {h}_{i - j}^{{k}_{1}} ( n + i ) {f}_{j}^{{k}_{2}} ( n ) \qquad ( 26 )$$

In this case, the general equation of the conversion between the signals in sub-bands, defined according to this form B, is expressed:

Y(n)=[g(Z,n)[X(n)]_{↑L}]_{↓M} (27)

It will therefore be understood that these two expression variants according to the form A or according to the form B are equivalent but different simply by the way the matrices g are calculated mathematically.

By taking up the formalism of the time-varying systems described hereinabove, an effort is now made to merge the operations induced by the conventional conversion scheme.

Hereinafter, the representations of the matrix operators g(n,Z) or g(Z,n) are denoted as follows:

According to the Form A:

$$g ( n , Z ) = {\sum }_{i = 0}^{{N}_{h} + {N}_{f} - 1} {g}_{i}^{A} ( n ) {Z}^{- i} \qquad ( 28 )$$

According to the Form B:

$$g ( Z , n ) = {\sum }_{i = 0}^{{N}_{h} + {N}_{f} - 1} {Z}^{- i} {g}_{i}^{B} ( n ) \qquad ( 29 )$$

Thus, at a given instant of index n, gᵢ^{A}(n) (respectively gᵢ^{B}(n)) defines the matrix of dimension M×L and comprising all the ith filtering coefficients gᵢ^{k}^{ᵢ}^{k}^{₂}(n) given by the relation (24) hereinabove (respectively given by the relation (26)).

The principles of the document FR-2,875,351 are now used, and, to this end, K=ppcm(L,M) is used to denote the smallest integer that is a common multiple of the numbers M and L.

p₁, p₂ are also used to denote the natural integers such that K=p₁M=p₂L.

Uⱼ(n) denotes the vector of the jth component of the polyphase decomposition of order p₂ of the vector X(n) defined by:

Uⱼ(n)=[Z^{j}X(n)]|_{↓p}_{₂}

The input vector X(n) of the signals in sub-bands is broken down as follows:

$$X ( n ) = {\sum }_{j = 0}^{{p}_{2} - 1} {Z}^{- j} [ {U}_{j} ( n ) ] {\vert}_{↑ {p}_{2}}$$

and the conversion equation (22) is expressed:

$$Y ( n ) = {\sum }_{j = 0}^{{p}_{2} - 1} [ g ( n , Z ) {Z}^{- j L} [ {U}_{L} ( n ) ] {\vert}_{↑ K} ] {\vert}_{↓ M} \qquad ( 30 )$$

Moreover, by breaking down the vector of the signals Y(n) into sub-bands in p₁ polyphase components such that Vᵢ(n)=[Z^{j}Y(n)]|_{↓p}_{₁}, where i=0, . . . , p₁, a new conversion equation is obtained for the ith polyphase component of the signal vector in sub-band Y(n) such that:

$${V}_{i} ( n ) = {\sum }_{j = 0}^{{p}_{2} - 1} [ g ( n + iM , Z ) {Z}^{i M - j L} ] {\vert}_{↓ K} {U}_{j} ( n ) \qquad ( 31 )$$

This equation (31) is important, because it represents the conversion of the polyphase components of order p₂ of the input signals to those of order p₁ of the output signals.

By using T(n,Z) to denote the global conversion matrix defined by the representation according to the form A, its filtering subelements A_{i,j}(n,Z) are such that

$$T ( n , Z ) = {( {A}_{i , j} ( n , Z ) )}_{{i = 0 , … , {p}_{1} - 1}_{j = 0 , … , {p}_{2} - 1}} \\ and , \\ {A}_{i , j} ( n , Z ) = [ g ( n + iM , Z ) {Z}^{i M - j L} ] {\vert}_{↓ K} \qquad ( 32 )$$

with i=0, . . . , p₁−1 and j=0, . . . , p₂−1.

It will be noted here that the sub-blocks A_{i,j}(n,Z) have the same dimension (L rows and M columns) as the matrix g, the coefficients of which are given in the relation (24) or (26) hereinabove (k₁ between 0 and M−1 and k₂ between 0 and L−1) and that the square global matrix T indeed comprises p₂L=K rows and p₁M=K columns.

Also noted will be a noteworthy characteristic of the sub-blocks A_{i,j}(n,Z) of the global conversion matrix T(n,Z). The sub-blocks A_{i,j}(n,Z) of the same index i can be calculated for one and the same instant i occurring in the expression n+iM for the calculation of the matrix g. With reference to FIG. 13A, these blocks A_{i,j}(n,Z) calculated for one and the same instant i are distributed over a “horizontal plane” of three-dimensional global conversion matrix T(n,Z). The conversion matrix T(n,Z) presents a depth (z axis as represented in FIG. 13A) corresponding to the dimension (or to the degree) of the filters. If it is made to represent the conversion matrix in two dimensions (projection perpendicular to the z axis), the sub-blocks calculated for one and the same instant i are distributed on one and the same row of sub-blocks.

The conversion equation is finally placed in a simpler form:

V(n)=T(n,Z)U(n) (33)

where U(n)=[U₀(n), . . . , Uₚ_{₂}₋₁(n)]* and V(n)=[V₀(n), . . . , Vₚ_{₁}₋₁(n)]* are the vectors of the polyphase components of the signals, respectively of order p₂ in input mode, and of order p₁ in output mode.

By now choosing an expression according to the form B, the expression g(Z,n) is used here according to the relation (25) to represent the successive filtering operations and a conversion equation is obtained with the form:

V(n)=T(Z,n)U(n) (34)

The conversion matrix T(Z,n) is then defined by sub-blocks A_{i,j}(Z,n) such that:

$$T ( n , Z ) = {( {A}_{i , j} ( Z , n ) )}_{{i = 0 , … , {p}_{1} - 1}_{j = 0 , … , {p}_{2} - 1}} \\ and , \\ {A}_{i , j} ( Z , n ) = [ {Z}^{i M - j L} g ( Z , n + jL ) ] {\vert}_{↓ K} \qquad ( 35 )$$

with i=0, . . . , p₁−1 and j=0, . . . , p₂−1.

Here, too, the sub-blocks A_{i,j}(Z,n) of the same index j can be calculated for one and the same instant j occurring in the expression n+jL for the calculation of the matrix g. With reference to FIG. 13B, these blocks A_{i,j}(Z,n) calculated for one and the same instant j are distributed over a “vertical plane” of the global conversion matrix T(n,Z). If a choice is made to represent the conversion matrix in two dimensions (projection perpendicular to the z axis), the sub-blocks calculated for one and the same instant j are distributed over one and the same column of sub-blocks.

It is then suggested that the sub-blocks of the global conversion matrix can be precalculated and stored in memory for different instants and, above all, for different allowable states. The sub-blocks associated with same instants can then be recovered from the memory according to the changes in time that occur in the coding formats. This property of a system according to the invention will be described in detail hereinbelow, notably with reference to FIG. 11.

In more general terms, the following steps are applied when the input vector comprises a number L of components in respective sub-bands and the output vector comprises a number M of components in respective sub-bands, after determination of a number K, the smallest common multiple between L and M:
serial/parallel conversion of the input vector to obtain p₂ polyphase component vectors, with p₂=K/L, and
parallel/serial conversion to obtain the output vector.

The conversion matrix is then applied to the p₂ polyphase components of the input vector to obtain p₁ polyphase components of the output vector, with p₁=K/M. In these conditions, the conversion matrix is square, of dimension K×K, and comprises p₁ rows and p₂ columns of sub-blocks Aᵢⱼ each comprising L rows and M columns. In particular, as observed hereinabove with reference to FIGS. 13A and 13B, sub-blocks Aᵢⱼ of one and the same index i (form A) or sub-blocks Aᵢⱼ of one and the same index j (form B) are precalculated for one and the same instant.

Thus, again, with reference to FIGS. 13A and 13B, the conversion matrix is three-dimensional, with:
a first dimension defined by the current index i of the sub-blocks,
a second dimension defined by the current index j of the sub-blocks,
and a third dimension (Z axis) defined by the degree of the matrix filtering.

The sub-blocks precalculated for one and the same instant then form the matrix planes extending towards the third dimension and are:
horizontal and precalculated for p₁ successive instants in an expression according to the form A,
or vertical and precalculated for p₂ successive instants in an expression according to the form B.

In the conversion between sub-band fields according to the invention, an effort is now made to minimize the algorithmic delay introduced by the processing of the signals in sub-bands.

To this end, advances are first introduced in the conventional conversion scheme of FIG. 6 to reduce the delay created by the filter banks. The aim is then to control the algorithmic delay by adding:
an advance Z^{a} at the input of the bank of synthesis filters,
an advance Z^{b} at the input of the bank of analysis filters,
   where a and b are numeric parameters to be determined.

The control of the algorithmic delay is in all ways compliant with that described in the document FR-2,875,351, except, nevertheless, that in this case the sub-blocks Aᵢⱼ are time-dependent.

In these conditions, the conversion matrix T(n,Z) defined by the field representation of all its elements, is such that:

A_{i,j}(n,Z)=[g(n+iM,z)Z^{aL+b+iM-jL}]|_{↓K} (36)
with i=0, . . . , p₁−1 and j=0, . . . , p₂−1.

The matrix sub-blocks g(n,Z) are such that:

$$\begin{matrix}g ( n , Z ) = H ( n , Z ) F ( Z , n + b ) \\ = {\sum }_{i = 0}^{{N}_{h} + {N}_{f} - 1} {g}_{i}^{A} ( n ) {Z}^{- i}\end{matrix} \qquad ( 37 )$$

with k₁=0, . . . , (M−1) and k₂=0, . . . , (L−1)
and the coefficients gᵢ^{k}^{₁}^{k}^{₂}(n) of gᵢ^{A}(n) are defined by:

$${g}_{i}^{{k}_{1} , {k}_{2}} ( n ) = {\sum }_{j} {h}_{j}^{{k}_{1}} ( n ) {f}_{i - j}^{{k}_{2}} ( n + b - i ) \qquad ( 38 )$$

The conversion matrix T(Z,n) according to the form B now, defined by the field representation of all its elements, is such that:

A_{i,j}(Z,n)=[Z^{aL+b+iM-jL}g(Z,n+(j−a)L)]|_{↓K} (39)
with i=0, . . . , p₁−1 and j=0, . . . , p₂−1.

The matrices g(Z,n) are such that:

$$\begin{matrix}g ( Z , n ) = H ( n - b , Z ) F ( Z , n ) \\ = {\sum }_{i = 0}^{{N}_{h} + {N}_{f} - 1} {Z}^{- i} {g}_{i}^{B} ( n )\end{matrix} \qquad ( 40 )$$

with k₁=0, . . . , (M−1) and k₂=0, . . . , (L−1)
and the coefficients gᵢ^{k}^{₁}^{k}^{₂}(n) of gᵢ^{B}(n) are defined by:

$${g}_{i}^{{k}_{1} , {k}_{2}} ( n ) = {\sum }_{j} {h}_{i - j}^{{k}_{1}} ( n - b + i ) {f}_{j}^{{k}_{2}} ( n ) \qquad ( 41 )$$

In both cases according to the form A or according to the form B, the exponent e_{i,j}=aL+b+iM−jL with i=0, . . . , p₁−1 and j=0, . . . , p₂−1 which appears in the construction of the conversion matrix, varies between the two limit values:

eₘᵢₙ=aL+b−K+L
for, i=0, j=p₂−1.

eₘₐₓ=aL+b+K−M
for, i=p₁−1, j=0.

The filters of the conversion matrix are causal if eₘₐₓ≦K−1 and, because of this, the following additional condition is obtained:

aL+b≦M−1

For a conversion system with minimum algorithmic delay, the maximum possible advance must be introduced. The choice of a and b is made advantageously so that eₘₐₓ=K−1, which means: aL+b=M−1

According to the construction equations of the filtering matrices g(n,Z) and g(Z,n) an advantageous choice of the integers (a,b) involves taking:

a=p₂−1 and, b=M+L−K−1 (42)

Nevertheless, a possible alternative to the determination of the pair of integers (a,b) consists in choosing a=0 and b=M−1.

In this case, the advance is controlled at the level of the intermediate signal \hat{x}(n) at the output of the bank of synthesis filters and at the input of the bank of analysis filters.

To construct the conversion matrix, an effort is made to identify the components of the polyphase breakdown of type 1 of order K of the matrix g(n+iM,Z). Two cases can then be distinguished according to the values of e_{i,j}=aL+b+iM−jL when i=0, . . . , p₁−1 and j=0, . . . , p₂−1:
if 0≦e_{i,j}≦K−1, the element of index i, j of the conversion matrix T(n,Z) is the e_{i,j}th polyphase component of type 1 of order K of g(n+iM,Z), such that:

$${A}_{i , j} ( n , Z ) = {\sum }_{m} {g}_{mK + {e}_{i , j}}^{A} ( nK + iM ) {Z}^{- m} \qquad ( 43 )$$

if (aL+b+L−K)≦e_{i,j}≦−1, the element of index i, j of the conversion matrix T(n,Z) is the (K+e_{i,j})th polyphase component of type 1 of order K of g(n+iM+K,Z), composed with a delay Z⁻¹, and the following is obtained:

$$\begin{matrix}\begin{matrix}{A}_{i , j} ( n , Z ) = {Z}^{- 1} [ g ( n + iM + K , Z ) {Z}^{K + {e}_{i , j}} ] {\vert}_{↓ K} \\ = {\sum }_{m} {g}_{( m + 1 ) K + {e}_{i , j}}^{A} ( nK + iM ) {Z}^{- m - 1}\end{matrix} & ( 44 )\end{matrix}$$

In the case of an expression according to the form B, to construct the conversion matrix, the components of the polyphase breakdown of type 2 of order K of the matrix g(Z,n+(j−a)L) are identified first of all. Two more cases are distinguished:
if 0≦e_{i,j}≦K−1, the element of index i, j of the conversion matrix T(Z,n) is the e_{i,j}th polyphase component of type 2 of order K of g(Z,n+(j−a)L) and the following therefore applies:

$${A}_{i , j} ( Z , n ) = {\sum }_{m} {Z}^{- m} {g}_{mK - {e}_{i , j}}^{B} ( nK + ( j - a ) L ) \qquad ( 45 )$$

if aL+b+L−K≦e_{i,j}≦−1, the element of index i, j of the conversion matrix T(Z,n) is the (K+e_{i,j})th polyphase component of type 2 of order K of g(Z,n+(j−a)L) composed with a delay Z⁻¹ and:

$$\begin{matrix}\begin{matrix}{A}_{i , j} ( Z , n ) = {Z}^{- 1} [ {Z}^{K + {e}_{i , j}} g ( Z , n + ( j - a ) L ) ] {\vert}_{↓ K} \\ = {\sum }_{m}^{ } {Z}^{- m - 1} {g}_{( m - 1 ) K - {e}_{i , j}}^{B} ( nK + ( j - a ) L )\end{matrix} & ( 46 )\end{matrix}$$

Hereinafter, a system with minimal delay is considered, where a and b are defined by the relation (42).

For the conversion systems defined according to the form A, when i=0, . . . , p₁−1 and j=0, . . . , p₂−1:
if 0≦e_{i,j}≦K−1, the sub-block A_{i,j}(n,Z) of T(n,Z) is such that:

$${A}_{i , j} ( n , Z ) = {\sum }_{m = 0}^{{N}_{{A}_{ij}} - 1} {A}_{i , j}^{m} ( n ) {Z}^{- m}$$

where the matrices A_{i,j}^{m}(n) are defined by A_{i,j}^{m}(n)=g_{mK+e}_{_{i,j}}^{A}(nK+iM),
if aL+b+L−K≦e_{i,j}≦−1, the sub-block A_{i,j}(n,Z) of T(n,Z) is such that:

$${A}_{i , j} ( n , Z ) = {\sum }_{m = 1}^{{N}_{{A}_{ij}}} {A}_{i , j}^{m} ( n ) {Z}^{- m}$$

where the matrices A_{i,j}^{m}(n) are defined by A_{i,j}^{m}(n)=g_{mK+e}_{_{i,j}}^{A}(nK+iM).

The length N_{A}_{ᵢⱼ} occurring in the maximum index of the terms of the sums hereinabove is defined by:

$${N}_{{A}_{ij}} = \{ \begin{matrix}⌊ \frac{{N}_{h} + {N}_{f} - 2}{K} ⌋ + 1 , & \begin{matrix}if 0 \leq {e}_{i , j} \leq {r}_{0} , \\ or if 0 \leq K + {e}_{i , j} \leq {r}_{0}\end{matrix} \\ ⌊ \frac{{N}_{h} + {N}_{f} - 2}{K} ⌋ , & \begin{matrix}if {r}_{0} + 1 \leq {e}_{i , j} \leq K - 1 , \\ or if {r}_{0} + 1 \leq K + {e}_{i , j} \leq K - 1\end{matrix}\end{matrix}$$

where r₀=(Nₕ+N_{f}−2)mod K, the notation “mod K” designating the function “modulo K”.

For the conversion systems defined according to the form B when i=0, . . . , p₁−1 and j=0 . . . p₂−1:
if 0<e_{i,j}≦(K−1), the sub-block A_{i,j}(Z,n) of T(Z,n) is expressed

$${A}_{i , j} ( Z , n ) = {\sum }_{m = 1}^{{N}_{{A}_{ij}} - 1} {Z}^{- m} {A}_{i , j}^{m} ( n )$$

the matrices A_{i,j}^{m}(n) being defined by A_{i,j}^{m}(n)=g_{mK-e}_{_{i,j}}^{B}(nK+(j−a)L),
if e_{i,j}=0, the sub-block A_{i,j}(Z,n) of T(Z,n) is expressed

$${A}_{i , j} ( Z , n ) = {\sum }_{m = 0}^{{N}_{{A}_{ij}} - 1} {Z}^{- m} {A}_{i , j}^{m} ( n )$$

the matrices A_{i,j}^{m}(n) being defined by A_{i,j}^{m}(n)=g_{mK}^{B}(nK+(j−a)L),
if aL+b+L−K≦e_{i,j}≦−1, the sub-block A_{i,j}(Z,n) of T(Z,n) is expressed

$${A}_{i , j} ( Z , n ) = {\sum }_{m = 2}^{{N}_{{A}_{ij}}} {Z}^{- m} {A}_{i , j}^{m} ( n )$$

the matrices A_{i,j}^{m}(n) being defined by A_{i,j}^{m}(n)=g_{mK}^{B}(nK+(j−a)L).

The length N_{A}_{ᵢⱼ} is determined by:

$${N}_{{A}_{ij}} = \{ \begin{matrix}⌊ \frac{{N}_{h} + {N}_{f} - 3}{K} + 1 ⌋ , & \begin{matrix}if 0 \leq {e}_{i , j} \leq {r}_{0} , \\ or if 0 \leq K + {e}_{i , j} \leq {r}_{0}\end{matrix} \\ ⌊ \frac{{N}_{h} + {N}_{f} - 3}{K} + 1 ⌋ - 1 , & \begin{matrix}if {r}_{0} + 1 \leq {e}_{i , j} \leq K - 1 , \\ or if {r}_{0} \leq K + {e}_{i , j} \leq K - 1\end{matrix}\end{matrix}$$

where r₀=(Nₕ+N_{f}−3+K)mod K.

To simplify the notations, the following representations will be used more simply hereinbelow:

$${A}_{i , j} ( n , Z ) = {\sum }_{m = 0}^{{N}_{T} - 1 } {A}_{i , j}^{m} ( n ) {Z}^{- m}$$

$$and , \\ {A}_{i , j} ( Z , n ) = {\sum }_{m = 0}^{{N}_{T} - 1 } {Z}^{- m} {A}_{i , j}^{m} ( n )$$

to represent the sub-blocks of the conversion matrices respectively defined in a form A or B.

Certain elements A_{i,j}^{m}(n) are identically zero and there is thus obtained a unique length N_{T} for all the components of the global conversion matrix, defined by:

$${N}_{T} = {max}_{i , j} ( {N}_{{A}_{ij}} ) + 1$$

A particular case is dealt with hereinbelow where the numbers of respective sub-bands are multiples of each other, with, first of all, M=pL.

This is the practical case where the number of sub-bands of the bank of analysis filters is an integer multiple of that of the bank of synthesis filters. The conversion between sub-band fields is then defined by the conversion equation:

$$\begin{matrix}\begin{matrix}Y ( n ) = {\sum }_{j = 0}^{p - 1} [ g ( n , Z ) {Z}^{M - 1 - jL} ] {\vert}_{↓ M} {U}_{j} ( n ) \\ = T ( n , Z ) U ( n )\end{matrix} & ( 47 )\end{matrix}$$

where the conversion matrix T(n,Z) is defined by:

T(n,Z)=[[g(n,Z)Z^{M-1}]|_{↓M}, [g(n,Z)Z^{M-L-1}]|_{↓M}, . . . , [g(n,Z)Z^{L-1}]|_{↓M}] (48)

The sub-blocks of the conversion matrix are the components (M−1−jL)th of the polyphase breakdown of type 1 of order M of g(n,Z), such that

$${A}_{j} ( n , Z ) = {\sum }_{m}^{ } {g}_{mM + M - 1 - jL}^{A} ( nM ) {Z}^{- m} \qquad ( 49 )$$

with j=0, . . . , p−1.

Furthermore, the relation (42) is chosen for the algorithmic delay parameters, or: a=p−1 and b=L−1 and, in these conditions, the elements gᵢ^{k}^{₁}^{k}^{₂}(n) of the filtering matrix g^{iA}(n) are determined by

$${g}_{i}^{{k}_{1} , {k}_{2}} ( n ) = {\sum }_{j}^{ } {h}_{j}^{{k}_{1}} ( n ) {f}_{i - j}^{{k}_{2}} ( n + L - 1 - i ) \qquad ( 50 )$$

There are two more possible alternatives to be noted concerning the choice of the algorithmic delay control parameters: (a,b)=(p,−1) or (a,b)=(0,M−1)

A second particular case is that where the number of sub-bands of the bank of synthesis filters is an integer multiple of that of the bank of analysis filters, or: L=pM.

Here, the choice of the advance parameters (42) is such that:
a=0 and b=M−1

Because of this, the elements gᵢ^{k}^{₁}^{,k}^{₂}(n) of the filtering matrix gᵢ^{B}(n) are determined by:

$${g}_{i}^{{k}_{1} , {k}_{2}} ( n ) = {\sum }_{j}^{ } {h}_{i - j}^{{k}_{1}} ( n - M + 1 + i ) {f}_{j}^{{k}_{2}} ( n ) \qquad ( 51 )$$

The conversion equation for the component Vᵢ(n), defined in the form B, becomes

Vᵢ(n)=[Z^{M-1+iM}g(Z,n)]|_{↓L}X(n)
with i=0, . . . , p−1.

The conversion between sub-band fields is defined by the conversion equation

V(n)=T(Z,n)X(n) (52)

where the conversion matrix T(Z,n) is defined by

T(Z,n)=[[Z^{M-1}g(Z,n)]|_{↓L}, [Z^{2M-1}g(Z,n)]|_{↓L}, . . . , [Z^{L-1}g(Z,n)]|_{↓L}]* (53)

Each sub-block of the conversion matrix corresponds to the M−1+iMth polyphase component of type 2 of order L of the filtering matrix g(Z,n) at the instant nL and the following is obtained:

$${A}_{i} ( Z , n ) = {\sum }_{m}^{ } {Z}^{- m} {g}_{mL - M + 1 - iM}^{B} ( nL ) \\ i = 0 , … , p - 1 \qquad ( 54 )$$

The basic equations of the inventive conversion have been given hereinabove. Hereinbelow, there follows a description of how to construct the main operators involved in a system according to the invention, and the practical implementation of the processing operations for the execution of the invention.

For the practical construction of the conversion system operators, the cases where the dimensions M and L are integer multiples of one another is first distinguished, followed by the general case where the smallest common multiple K is different from the respective numbers of sub-bands L and M. In practice, the cases where the dimensions are integer multiples of one another are described first, for greater clarity of the explanation, with a view to the construction of the main conversion matrices T(n,Z) (according to the form A) or T(Z,n) (according to the form B).

The conversion for the case where M=pL is preferably defined by an application of the form A of filtering operations. The reciprocal case where L=pM is preferably defined by an application of the form B. In both cases, the construction of the main conversion matrices is in two steps.

In particular, in the case M=pL:
the submatrix g(n,Z) is constructed, for which the coefficients are defined by the relation (50):

$${g}_{i}^{{k}_{1} , {k}_{2}} ( n ) = {\sum }_{j}^{ } {h}_{j}^{{k}_{1}} ( n ) {f}_{i - j}^{{k}_{2}} ( n + L - 1 - i )$$

where k₁=0, . . . , M−1, k₂=0, . . . , L−1 and i=0, . . . , (Nₕ+N_{f}−2),
then, the p polyphase components of type 1 of order M of g(n,Z) are constructed, such that:

[g(n,Z)Z^{M-1-jL}]|_{↓M}

with j=0, . . . , p−1, and a concatenation of these p blocks of polyphase components is applied to ultimately obtain the global matrix T(n,Z), defined by the relation (48):

T(n,Z)=[[g(n,Z)Z^{M-1}]|_{↓M}, . . . , [g(n,Z)Z^{L-1}]|_{↓M}]

In the case where L=pM:
the matrix g(Z,n) is constructed, for which the coefficients are defined by the relation (51):

$${g}_{i}^{{k}_{1} , {k}_{2}} ( n ) = {\sum }_{j}^{ } {h}_{i - j}^{{k}_{1}} ( n - M + 1 + i ) {f}_{j}^{{k}_{2}} ( n )$$

where k₁=0, . . . , M−1, k₂=0, . . . , L−1 and i=0, . . . , (Nₕ+N_{f}−2),
then, the main conversion matrix T(Z,n) is constructed, defined by:

T(Z,n)=[[Z^{M-1}g(Z,n)]|_{↓L}, . . . , [Z^{L-1}g(Z,n)]|_{↓L}]*
where each sub-block of the conversion matrix is the (M−1+iM)th polyphase component of type 2 of order L of the submatrix g(Z,n) at the instant nL.

first Particular Case M=pL

For the case where M=pL, the filtering coefficients of the synthesis (respectively analysis) banks are constant by piece and vary according to the instant n, in particular at the instants that are multiples of L (respectively of M). Because of this, to effect the convolution products of the impulse responses of the two filter banks

$${\sum }_{j}^{ } {h}_{j}^{{k}_{1}} ( n ) {f}_{i - j}^{{k}_{2}} ( n + L - 1 - i ) ,$$

the time variations of the impulse responses of F(Z,n+L−1−i) when i=0, . . . , (Nₕ+N_{f}−2) must be taken into account. In effect, the numbering index i of the coefficients of a matrix block gᵢ^{A}(n) appears in the convolution product, both as convolution index and as time variable. This concept of “matrix block” will be described later with reference to FIG. 8A.

Because of this:
if (Nₕ+N_{f}−2)≦L, at an instant n′=nL, the coefficients of the filters F(Z,nL+L−1−i) are constructed whatever the value of i=0, . . . , Nₕ+N_{f}−2,
if (Nₕ+N_{f}−2)>L, the impulse responses of F⁰(Z,n+L−1−i), . . . , F^{L-1}(Z,n+L−1−i) of the synthesis bank F(Z,n+L−1−i) perform a change of state at least once with the index i.

In the latter case, to construct the matrix sub-block at a given instant, it is necessary to have several successive states of the bank of synthesis filters and the current state of the bank of analysis filters.

Reference is now made to FIG. 7 illustrating the conversion between two transforms TV-MLT. It is indicated that Nₕ=2M₁, N_{f}=2L₁ and in this case, i=0, . . . , 2(p+1)L₁−2. Thus, to determine the state of the submatrix g(n′,Z) at an instant n′=nM₁, the following partial convolution operations are carried out:

$${g}_{i}^{{k}_{1} , {k}_{2}} ( {nM}_{1} ) = \{ \begin{matrix}{\sum }_{j}^{ } {h}_{j}^{{k}_{1}} ( {nM}_{1} ) {f}_{i - j}^{{k}_{2}} ( {nM}_{1} ) & if , i = 0 , … , {L}_{1} - 1 \\ {\sum }_{j}^{ } {h}_{j}^{{k}_{1}} ( {nM}_{1} ) {f}_{i - j}^{{k}_{2}} ( {nM}_{1} - {L}_{1} ) & if , i = {L}_{1} , … , 2 {L}_{1} - 1 \\ ⋮ & ⋮ \\ {\sum }_{j}^{ } {h}_{j}^{{k}_{1}} ( {nM}_{1} ) {f}_{i - j}^{{k}_{2}} ( {nM}_{1} - ( 2 p + 1 ) {L}_{1} ) & if , i = ( 2 p + 1 ) {L}_{1} , … , 2 ( p + 1 ) {L}_{1} - 2\end{matrix} \qquad ( 55 )$$

To construct the matrix g(nM₁,Z) according to the relations for calculating its coefficients given hereinabove, there are supplied, on the one hand, the coefficients of the analysis bank H(nM₁,Z) and, on the other hand, the coefficients of the filters of the 2p+2 synthesis banks:

F(Z,nM₁), F(Z,nM₁−L₁), . . . , F(Z,nM,−(2p+1)L₁), which follow each other in time. This processing operation amounts to performing 2p+2 convolution products and concatenating 2p+2 obtained segments, of length L₁, to obtain the coefficients gᵢ^{A}(nM₁) for all i=0, . . . , 2(p+1)L₁−1. If, for example, p=2, the 2p+2=6 successive states of the bank of synthesis filters about the instant n′=nM₁ are combined, to calculate the convolution products and obtain “blocks” (FIG. 8A) g₀^{A}(nM₁), . . . , g_{2(p+1)L}_{₁}₋₁^{A}(nM₁) which define the state of the submatrix g(n′,Z) at the instant n′=nM₁.

The result is valid for the general case of the conversion between two TV-MLT transforms. Moreover, in the general case of two banks of filters, the lengths of which are determined by Nₕ and N_{f}, the term:

Δ_{f}=[(Nₕ+N_{f}−1)/L]+1 (56)

is determined, corresponding to the number of successive states of the bank of synthesis filters, and the convolution products are calculated according to the relation (50) with a single state of the bank of analysis filters to determine all the matrix “blocks” gᵢ^{A}(nM).

This construction is illustrated in FIG. 8A, which diagrammatically shows the groupings produced to obtain the convolution products of the successive states of the bank of synthesis filters with those of the bank of analysis filters. In the example represented in FIG. 8A, p=3 and Δ_{f}=4, in the M=pL case.

With these groupings, it is then possible to calculate the states of the submatrix g(n′,Z) at the instants n′=nM, (n+1)M, (n+2)M, . . . etc.

Then, for the construction of the global conversion matrix, the sub-blocks of this global conversion matrix T(n,Z)=[A₀(n,Z), . . . , Aₚ₋₁(n,Z)] are the (M−1−jL)th components of the polyphase breakdown of type 1, of order M, of the submatrix g(n,Z), with:

$${A}_{j} ( n , Z ) = {\sum }_{m = 0}^{{N}_{T} - 1 } {g}_{mM + M - 1 - jL}^{A} ( nM ) {Z}^{- m}$$

where j=0, . . . , p−1.

When the submatrix g(n,Z) is determined, it therefore remains to extract and order the matrix “blocks” gᵢ^{A}(nM) to construct each sub-block of the global matrix T(n,Z). It will then be noted that these matrix blocks gᵢ^{A}(nM) are all determined for one and the same instant nM. With reference to FIGS. 13A and 13B, these are plans perpendicular to the Z axis and each defined for a power of Z, since it will be remembered that the Z axis represents the dimension of the filters.

Thus, a state of the global conversion matrix T(n,Z) is defined following the determination of N_{T} matrix blocks of size M×M. Hereinbelow, Pₘ(n) is used to denote the matrix block of index m of the conversion matrix T(n,Z), defined at the instant of index n by

Pₘ(n)=[g_{mM+M-1}^{A}(nM), . . . , g_{mM-1+L}^{A}(nM)] (57)

where m=0, . . . , (N_{T}−1). Because of this, the conversion matrix T(n,Z) defined by the relation (48) is also expressed:

$$T ( n , Z ) = {\sum }_{m = 0}^{{N}_{T} - 1 } {P}_{m} ( n ) {Z}^{- m} \qquad ( 58 )$$

The number N_{T} of matrix blocks P₀(n), . . . , P_{N}_{_{T}}₋₁(n) is defined by the value of the maximum length of the polyphase components of order M of g(n,Z) such that:

$${N}_{T} = [ \frac{{N}_{h} + {N}_{f} - 2}{M} ] + 1 \qquad ( 59 )$$

Thus, the matrix T(n,Z), expressed in the form A, preferred in the case M=pL, is expressed as a function of the sub-blocks Aⱼ according to the relations given hereinabove, and each sub-block Aⱼ is expressed as a function of the matrices g, the coefficients gᵢ^{k}^{₁}^{k}^{₂}(n) of which depend on the coefficients of the filters hₖ and fₖ which are themselves determined as a function of the four possible cases illustrated in FIG. 4B. Finally, the conversion matrix T(n,Z) is fully constructed.

Second Particular Case L=pM

There now follows a description of the construction of the submatrix g(Z,n) for the case where L=pM. The main difference from the preceding case M=pL is that the conversion matrices are preferably defined in the form of type B. The calculation of the filtering coefficients gᵢ^{k}^{₁}^{k}^{₂}(n) is determined by:

$${g}_{i}^{{k}_{1} , {k}_{2}} ( n ) = {\sum }_{j}^{ } {h}_{i - j}^{{k}_{1}} ( n - M + 1 + i ) {f}_{j}^{{k}_{2}} ( n )$$

The same property is found on the index i which is both a convolution index and a time variable. It is therefore essential to take account of the variations of the bank of analysis filters H(n−M+1+i,Z), that is, the changes of states of the bank of filters, during the calculation of the matrix blocks g₀^{B}(n), . . . , g_{Nh+N}_{_{f}}₋₂^{B}(n).

FIG. 8B illustrates the grouping of the states of the bank of analysis filters which is used to determine the states of the submatrix g(Z,n′) at the instants n′=nM₁, (n+1)M₁, (n+2)M₁, . . . .

In the example represented, p=3 and Δₕ=4, this quantity:

Δₕ=[(Nₕ+N_{f}−1)/M]+1 (60)

determining the number of successive states of the bank of analysis filters H(n−M+1+i,Z) grouped with a state of the bank of synthesis filters F(Z,n) and making it possible to calculate a state of the submatrix g(Z,n) according to a partial convolution.

In this second particular case where L=pM, the conversion matrix T(Z,n) is defined by:

T(Z,n)=[[Z^{M-1}g(Z,n)]|_{↓L}, . . . , [Z^{L-1}g(Z,n)]|_{↓L]*}

each sub-block Aᵢ(Z,n) of the main conversion matrix is the (M−1+iM)th polyphase component of type 2 of order L of g(Z,n) at the instant nL, and the following is obtained:

$${A}_{i} ( Z , n ) = {\sum }_{m}^{ } {Z}^{- m} {g}_{mL - M + 1 - iM}^{B} ( nL )$$

where i=0, . . . , p−1.

A state of the main conversion matrix T(Z,n) is constructed from the datum of the state g(Z,n) at the instant nL. The matrix blocks of g(Z,nL), determined for one and the same instant nL, still have to be extracted and ordered, to identify the polyphase components of type 2 of order L. The latter step is also similar to that described in the document FR-2,875,351 for the construction of the conversion matrix T(z) from g(z).

The conversion matrix T(Z,n) is therefore defined by the datum, at each instant n, of its N_{T} matrix blocks of size L×L. Pₘ(n) is used to denote the matrix block of index m of the conversion matrix T(Z,n), defined at the instant n by

Pₘ(n)=[g_{mL-M+1}^{B}(nL), . . . , g_{(m-1)L+1}^{B}(nL)] (61)

with m=0, . . . , (N_{T}−1). Because of this, the conversion matrix T(Z,n) defined by the relation (53), is also expressed:

$$T ( Z , n ) = {\sum }_{m = 0}^{{N}_{T} - 1 } {Z}^{- m} {P}_{m} ( n ) \qquad ( 62 )$$

The number N_{T} of matrix blocks P₀(n), . . . , P_{N}_{_{T}}₋₁(n) is defined by the value of the maximum length of the polyphase components of order L of g(Z,n), here such that

$${N}_{T} = [ \frac{{N}_{h} + {N}_{f} - 3}{L} + 1 ] \qquad ( 63 )$$

Here too, the conversion matrix T(Z,n) has been fully constructed at this stage.

General Case K=ppcm(L,M)

Form A

In the general case now, where the respective numbers of filters in the banks are not multiples of one another (K=ppcm(L,M)), in the form A, the determination of the states of the submatrix g(n,Z) is defined by the calculation of all its filtering coefficients gᵢ^{k}^{₁}^{k}^{₂}(n) such that:

$${g}_{i}^{{k}_{1} , {k}_{2}} ( n ) = {\sum }_{j}^{ } {h}_{j}^{{k}_{1}} ( n ) {f}_{i - j}^{{k}_{2}} ( n + b - i )$$

with k₁=0, . . . , (M−1) and k₂=0, . . . , (L−1) and the algorithmic delay control parameters are determined by the solutions given in the relations (42). Here too, groupings of Δ_{f} successive states of the bank of synthesis filters are obtained to produce a partial convolution product, with a state of the bank of analysis filters H(n,Z) (FIG. 9A).

The main conversion matrix T(n,Z) is defined by the construction of its sub-blocks A_{i,j}(n,Z) such that:

A_{i,j}(n,Z)=[g(n+iM,Z)Z^{aL+b+iM-jL}]|_{↓K}
where i=0, . . . , p₁−1 et j=0, . . . , p₂−1.

When 0≦e_{i,j}≦K−1, the element A_{i,j}(n,Z) of the main conversion matrix T(n,Z) is the e_{i,j}th polyphase component of type 1 of order K of the matrix g(n+iM,Z) and therefore

$${A}_{i , j} ( n , Z ) = {\sum }_{m}^{ } {g}_{mK + {e}_{i , j}}^{A} ( nK + iM ) {Z}^{- m}$$

The current index i designates both the number of the polyphase component with e_{i,j} and a time advance iM. In these conditions, the constructions of a state of the main conversion matrix is determined by the datum of p₁ successive states of g(n′,Z) taken at the instants n′=nK, nK+M, . . . , (n+1)K−M.

This property is also verified for the polyphase components e_{i,j} such that (aL+b+L−K)≦e_{i,j}≦−1. The element A_{i,j}(n,Z) of the main conversion matrix T(n,Z) is the (K+e_{i,j})th polyphase component of type 1 of order K of g(n+iM+K,Z) composed with a delay Z⁻¹, or:

$${A}_{i , j} ( n , Z ) = {\sum }_{m}^{ } {g}_{( m + 1 ) K + {e}_{i , j}}^{A} ( nK + iM ) {Z}^{- m - 1}$$

The states of g(n′,Z) taken at the instants n′=nK, nK+M, . . . , (n+1)K−M are therefore determined to construct a state of the main conversion matrix.

FIG. 9A illustrates the groupings of several states of g(n,Z) making it possible to calculate a state of the conversion matrix. In the example represented, p₁=3 and p₂=4 have been chosen. A state of g(n′,Z) at the instant n′=nK+iM makes it possible to extract the series of polyphase components A_{i,j}(n,Z) with i=0, . . . , p₂−1. This series represents a row of p₂ components out of the p₁ rows of T(n,Z). It is important to observe, in this FIG. 9A, that the ordering of the polyphase components A_{i,j}(n,Z) represents the states of the transposed matrix T′(n,Z) of T(n,Z).

General Case K=ppcm(L,M)

Form B

In the form B of the operators, and still in the general case, the states of g(Z,n) are determined by the calculation of the filtering coefficients gᵢ^{k}^{₁}^{k}^{₂}(n) such that:

$${g}_{i}^{{k}_{1} , {k}_{2}} ( n ) = {\sum }_{j}^{ } {h}_{i - j}^{{k}_{1}} ( n - b + i ) {f}_{j}^{{k}_{2}} ( n )$$

with k₁=0, . . . , (M−1) and k₂=0, . . . , (L−1)
   and the algorithmic delay control parameters are determined by the solutions of the relations (42). Δₕ successive states of the bank of analysis filters must be grouped together to obtain a partial convolution product with a state of the bank of synthesis filters F(n,Z) (FIG. 9B).

The main conversion matrix is determined by the field representation of all the sub-blocks A_{i,j}(Z,n) such that

A_{i,j}(Z,n)=[Z^{aL+b+iM-jL}g(Z,n+(j−a)L)]|_{↓K}
with i=0, . . . , p₁−1 and j=0, . . . , p₂−1.

When 0≦e_{i,j}≦K−1, the element A_{i,j}(Z,n) of the conversion matrix T(Z,n) is the e_{i,j}th polyphase component of type 2 of order K of g(Z,n+(j−a)L) and therefore

$${A}_{i , j} ( Z , n ) = {\sum }_{m}^{ } {Z}^{- m} {g}_{mK - {e}_{i , j}}^{B} ( nK + ( j - a ) L ) .$$

It will be noted that the index j occurs both in the polyphase component number e_{i,j} and in the time advance (j−a)L. Because of this, to calculate the state of the main conversion matrix at the instant n, p₂ successive states of g(Z,n′) associated with the instants n′=(n−1)K+L, (n−1)K+2L, . . . , nK(a=p₂−1) are determined.

This grouping makes it possible to also construct the polyphase component e_{i,j} such that aL+b+L−K≦e_{i,j}≦−1. The element A_{i,j}(Z,n) of the main conversion matrix T(Z,n) is the (K+e_{i,j})th polyphase component of type 2 of order K of g(Z,n+(j−a)L), composed with a delay Z⁻¹. It is expressed:

$${A}_{i , j} ( Z , n ) = {\sum }_{m}^{ } {Z}^{- m - 1} {g}_{( m - 1 ) K - {e}_{i , j}}^{B} ( nK + ( j - a ) L )$$

For the same reason, p₂ states of g(Z,n′) associated with the instants n′=(n−1)K+L, (n−1)K+2L, . . . , nK, are determined first, to construct all the polyphase components that form a state of the main conversion matrix.

FIG. 9B illustrates the construction of the conversion matrix corresponding to the case where p₁=4 and p₂=3. A state of g(Z,n′) taken at the instant n′=(n−1)K+(j+1)L makes it possible to construct a complete column, made up of p₁ polyphase components A_{i,j}(Z,n) with i=0, . . . , p₁−1. Finally, the global conversion matrix at each instant is obtained following the construction of the p₂ columns.

There now follows a definition of the conversion system according to the invention.

For the case where M=pL, the conversion relation (47) established in the form Y(n)=T(n,Z)U(n) defines, in the form A, a time-varying matrix filtering of the vector U(n) by the global matrix T(n,Z). The signals in successive sub-bands Y(n), Y(n+1), . . . , Y(n+N_{T}−1) are obtained by the operations:

$$Y ( n ) = {P}_{0} ( n ) U ( n ) + {P}_{1} ( n ) U ( n - 1 ) + … + {P}_{{N}_{T} - 1} ( n ) U ( n - {N}_{T} + 1 )$$

$$Y ( n + 1 ) = {P}_{0} ( n + 1 ) U ( n + 1 ) + {P}_{1} ( n + 1 ) U ( n ) + … + {P}_{{N}_{T} - 1} ( n + 1 ) U ( n - {N}_{T} + 2 )$$

$$⋮$$

$$Y ( n + {N}_{T} - 1 ) = {P}_{0} ( n + {N}_{T} - 1 ) U ( n + {N}_{T} - 1 ) + … + {P}_{N + 1} ( n + {N}_{T} - 1 ) U ( n )$$

The diagram of FIG. 10A illustrates one implementation of the conversion (with N_{T}32 3 in the example represented) of the signals in successive sub-bands U(n), . . . , U(n+3). It therefore appears that the conversion system can be constructed by simple transform matrices, followed by an addition with overlap of the blocks of the transformed vectors.

For the other particular case of the conversions where L=pM, the conversion relation is established in the form V(n)=T(Z,n)X(n) and represents a time-varying matrix filtering of type B of the vector of the signals in sub-bands X(n) by the conversion operator T(Z,n). The conversion is performed directly on the signals in sub-bands at the input of a code converter, whereas a polyphase breakdown of order p of the signals is performed after conversion. The successive polyphase components V(n), V(n+1), . . . , V(n+N_{T}−1), of order p, are obtained by the operations:

$$V ( n ) = {P}_{0} ( n ) X ( n ) + {P}_{1} ( n - 1 ) X ( n - 1 ) + … + {P}_{{N}_{T} - 1} ( n - {N}_{T} + 1 ) X ( n - {N}_{T} + 1 )$$

$$V ( n + 1 ) = {P}_{0} ( n + 1 ) X ( n + 1 ) + {P}_{1} ( n ) X ( n ) + … + {P}_{{N}_{T} - 1} ( n - {N}_{T} + 2 ) X ( n - {N}_{T} + 2 )$$

$$⋮$$

$$V ( n + {N}_{T} - 1 ) = {P}_{0} ( n + {N}_{T} - 1 ) X ( n + {N}_{T} - 1 ) + … + {P}_{N + 1} ( n ) X ( n )$$

The diagram of FIG. 10B illustrates the conversion (here with N_{T}=3) of the signals in successive sub-bands X(n), . . . , X(n+3). It again appears that the conversion system can be implemented by transform matrices, followed by an addition with overlap.

There now follows a description of an example of operation of the global conversion system according to the invention.

Referring to FIG. 11, a conversion system between representations of the signal in different sub-band fields comprises a serial/parallel conversion module SPC for the incoming signal vector X(n′) comprising the components x₀(n′), . . . , X_{L-1}(n′) in respective sub-bands. The module SPC performs the equivalent of a polyphase breakdown of order p₂ of the signal vector X(n′), to deliver p₂ components U₀(n), . . . , Uₚ_{₂}₋₁(n) of a vector U(n).

These components of the vector U(n) are then applied to a time-varying matrix filtering module MFM characterized by the global conversion matrix T(n,Z) (or T(Z,n) depending on the form B) of the type defined hereinabove. The MFM module then uses time-varying conversion matrices.

The p₁ components V₀(n), . . . , Vₚ_{₁}₋₁(n) of the vector V(n) obtained from the matrix filtering module MFM are finally applied to a parallel/serial conversion module PSC, which delivers the components y₀(n″), . . . , y_{M-1}(n″) of the output signal vector Y(n″). The PSC module then performs the equivalent of a recombination of the polyphase components of order p₁. The output signal Y(n″), duly converted, can be used in its new format, for example, by quantization and coding, or conveyed, or even stored for future applications.

The set of these three successive processing operations performed by the SPC, MFM and PSC modules is indicated by an outline SYS in broken lines in FIG. 11 to illustrate the modules performing the conversion proper. It is also indicated that a switchover control module SW can detect the best time/frequency resolution, given, for example, the stationarity properties of the incoming signals. This control can advantageously control the mechanism for switching states from a plurality of allowable states, notably those described with reference to the different windows of FIG. 4B. Generally, it is indicated that the switchover control module SW can search in the memory DD for all the sub-blocks precalculated as a function of all the possible states of the conversion matrix T, for example matrix blocks by matrix blocks.

An example of operation of a switchover command SW is illustrated in FIG. 14. A clock HOR (step H145) determines a current instant t. The conversion matrix T has been determined at an instant t=nKTₑ, (with K=ppcm(L,M) in the general case, where Tₑ is the sampling period of the signal to be processed in the time domain). If this instant t has reached a subsequent instant (n+1)KTₑ (test T141), the matrix T must be redetermined. Nevertheless, it is verified that the properties of the signal have not changed (test T142), in which case the matrix blocks recovered from the memory DD (step S146) are given for different states (state AM144) from those recovered for the preceding instant nKTₑ (step AM143). According to the state defined in the test T142, the matrix T is determined (step S147) until a next instant (n+2)KTₑ (loop S148). In the example represented, it is therefore possible to analyze the properties of the signal in the test T142, every KTₑ instants, to globally construct the matrix T.

In an embodiment variant illustrated in FIG. 14, since the rows (form A) or the columns (form B) of sub-blocks Aᵢⱼ of the conversion matrix T are precalculated for the same instants, it is possible to increase the frequency of the test T142 on the properties of the signal, or therefore reduce the period of execution of the test T142 to MTₑ (for the form A) or to LTₑ (for the form B) and recover matrix blocks that are up to date as to the time variation of the abovementioned possible states. One such variation, possibly occurring within a period KTₑ, will then be detected and taken into account for the construction of the matrix T.

Thus, in this variant, the global conversion matrix T is progressively constructed by calls to the memory DD at successive instants for which the sub-blocks Aᵢⱼ have been precalculated.

The loop control SW of FIG. 11 therefore manages the calls to memory DD for the states of the conversion matrix. The memory DD delivers, in return, the matrix blocks denoted P₀(n), . . . , P_{N}_{_{T}}₋₁(n) precalculated for one and the same instant n. It is advantageous to provide for this purpose a fast memory. Thus, the blocks P₀(n), . . . , P_{N}_{_{T}}₋₁(n) can be precalculated by taking into account the various allowable states, whereas the calls to memory DD of these filtering blocks can be performed on the fly, at each successive instant nK (or, in the abovementioned variant of FIG. 14: at each instant nM or nL to call rows (form A) or columns (form B) of sub-blocks and progressively calculate the global conversion matrix T).

A relation is specified hereinbelow between the index n relating to the states of the conversion system, on the one hand, and the time indices denoted n′ and n″ in FIG. 11, relating to the signals in sub-bands.

To this end, fₑ is used to denote the sampling frequency of the time signal Xₜ and fₓ to denote the sampling frequency of the signals in sub-bands X(n′). By construction, the signals X(n′) are signals in sub-bands defined in the transform domain of the bank of synthesis filters and a relation of the type fₓ=fₑ/L applies.

The serial/parallel conversion corresponds to a polyphase breakdown of order p₂ of each of the subsignals. Because of this, the sampling frequency, denoted fᵤ, of the component vectors U(n) is p₂ times smaller such that: fᵤ=fₓ/p₂

In principle, the conversion of the vectors U(n) in order to obtain the vectors V(n) does not involve changing frequency. Consequently, the sampling frequency fᵥ relating to V(n) is such that fᵥ=fᵤ.

On the other hand, the parallel/serial conversion corresponds to a recombination of the polyphase components of order p₁ of the signal in sub-bands Y(n″). f_{y} is used to denote the sampling frequency of the signals in output sub-bands, such that:

f_{y}=p₁fᵥ

Consequently to guarantee the rate adaptation of the three samplings that occur in the conversion system, the three time indices n′, n and n″ satisfy the equality relation:

n′L=nK=n″M

with K=ppcm(L,M).

Because of this, at a given sampling frequency fₑ, relating to the time domain, a new L-uplet of coefficients in sub-bands X(n′) arrives at the input of the conversion system at the instants that are multiples of L, that is, after a time equal to L/fₑ has elapsed. The changes of state of the conversion matrix occur at the instants that are multiples of K. The filtering blocks P₀(n), . . . , P_{N}_{_{T}}₋₁(n) therefore arrive in return from the memory when a time K/fₑ has elapsed in the embodiment illustrated by way of example in FIG. 14. It will also be noted that, in the abovementioned variant of this FIG. 14, it is again possible to deliver the rows (form A) or the columns (form B) of sub-blocks Aᵢⱼ for the same instants n, every M/fₑ or every L/fₑ respectively, to progressively construct the matrix T.

Finally, a new M-uplet of coefficients in sub-bands at the instants that are multiples of M, that is after a time M/fₑ has elapsed, is delivered at the output of the conversion system.

Thus, in more general terms, for the form A, the signal to be processed being digital and sampled initially at a period Tₑ, the global conversion matrix is determined periodically for instants that are multiples of a quantity KTₑ and expressed according to matrices of type g(n,Z), themselves calculated for successive instants that are multiples of a quantity MTₑ.

In particular, the calculation of the coefficients of each matrix of type g(n,Z) at an instant that is a multiple of the quantity MTₑ, is then performed by taking:
Δ_{f} successive sets (or “allowable states”) of coefficients of the bank of synthesis filters determined for Δ_{f} successive instants in a period MTₑ, and from an instant that is a multiple of MTₑ,
and a set of coefficients of the bank of analysis filters determined for this instant that is a multiple of MTₑ,
   and by applying a partial convolution between the successive sets of coefficients of the synthesis bank and the coefficients of the analysis bank,
   with Δ_{f}=[(Nₕ+N_{f}−1)/L]+1, where Nₕ and N_{f} are the respective lengths of the analysis and synthesis filters.

For the form B, the global conversion matrix is determined periodically for instants that are multiples of a quantity KTₑ and expressed according to matrices of type g(Z,n), themselves calculated for successive instants that are multiples of a quantity LTₑ.

More particularly, the calculation of the coefficients of each matrix of type g(Z,n) at an instant that is a multiple of the quantity LTₑ is then performed by taking:
Δₕ successive sets (or “allowable states”) of coefficients of the bank of analysis filters determined for Δₕ successive instants in a period LTₑ, and from an instant that is a multiple of LTₑ,
and a set of coefficients of the bank of synthesis filters determined for this instant that is a multiple of LTₑ,
   and by applying a partial convolution between said successive sets of coefficients of the analysis bank and the coefficients of the synthesis bank,
   with Δₕ=[(Nₕ+N_{f}−1)/M]+1, where Nₕ and N_{f} are the respective lengths of the analysis and synthesis filters.

There now follows a description of how the conversion according to the invention can be represented by a diagram similar to a representation by a linear system, periodically varying in time, or LPTV (for “Linear Periodically Time Varying”) system, described in the document FR-2,875,351. Hereinbelow, a representation similar in this way to a representation by an LPTV system will be noted “s-LPTV”.

Implementation According to Form A

In the form A, for i=0, . . . , p₁−1, the conversion relation is such that the polyphase component numbered i of the signals in output sub-bands is determined by

$$\begin{matrix}\begin{matrix}{V}_{i} ( n ) = {\sum }_{j = 0}^{{p}_{2} - 1} {A}_{i , j} ( n , Z ) {U}_{j} ( n ) \\ = {\sum }_{j = 0}^{{p}_{2} - 1} {\sum }_{m = 0}^{{N}_{T} - 1} {A}_{i , j}^{m} ( n ) {Z}^{- m} {U}_{j} ( n ) \\ = {\sum }_{j = 0}^{{p}_{2} - 1} {\sum }_{m = 0}^{{N}_{T} - 1} {A}_{i , j}^{m} ( n ) {U}_{j} ( n - m )\end{matrix} & ( 64 )\end{matrix}$$

In these conditions, and taking into account the form A, a subsystem numbered i is obtained which delivers the component Vᵢ(n) of the output signal as represented in FIG. 12A. As an illustration, a switch COM is represented at the input of the subsystem, to diagrammatically represent the “path” of the p₂ stages of the subsystem in turn. The filtering operations performed by the subsystem are characterized by the components A_{i,j}(n,Z) of the main conversion matrix (with j=0, . . . , p₂−1).

The operation of the global conversion system, in the general case, defined in the form A, can be seen as the structure of FIG. 12B. It then comprises p₁ time-varying linear subsystems and the “switch” COM1 at the input operates periodically (with a period p₂/fₓ).

Each subsystem from this set (numbered i with i=0, . . . , p₁−1 in FIG. 12B) is characterized by the p₂ filters A_{i,j}(n,Z) with j=0, . . . , p₂−1. These subsystems operate in parallel and the output “switch” COM2 also chooses one of their outputs periodically as output for the conversion system with a period p₁/f_{y}. The filtering coefficients of the main conversion matrix T(n,Z) vary with time and its changes of state are applied after each period of duration K/fₑ. The global system is therefore equivalent to a linear system, periodically time varying, and the period K/fₑ with:

K=p₂L=p₁M and fₑ=Lfₓ=Mf_{y}

The two switches at the input COM1 and at the output COM2 of the system operate with a frequency fₑ/K which corresponds to the frequency of changes of state of the components A_{i,j}(n,Z).

The output Y(n) of the conversion, at the instant n/f_{y} is equal to the output of the subsystem s-LPTV numbered i, at the instant n/f_{y}, when i=n mod p₁. The input X(n), at the instant k/fₓ, contacts the connections numbered j of each of the p₁ subsystems s-LPTV when j=k mod p₂.

In the particular case where M=pL, it is sufficient to put down simply p₁=1 and p₂=p and the conversion equation is reduced to:

$$Y ( n ) = {\sum }_{j = 0}^{p - 1} {\sum }_{m = 0}^{{N}_{T} - 1} {A}_{j}^{m} ( n ) {U}_{j} ( n - m )$$

The representation of the system as an s-LPTV system, in this particular case, corresponds in all points to the diagram of the figure completely represented by the structure of FIG. 12A and the output Vᵢ(n) corresponds directly to the signal Y(n) in sub-bands after conversion.

Implementation According to the Form B

For i=0, . . . , p₁−1, the conversion equation defined in the form B is such that the polyphase component numbered i of the signals in output sub-bands is determined by

$$\begin{matrix}\begin{matrix}{V}_{i} ( n ) = {\sum }_{j = 0}^{{p}_{2} - 1} {A}_{i , j} ( Z , n ) {U}_{j} ( n ) \\ = {\sum }_{j = 0}^{{p}_{2} - 1} {\sum }_{m = 0}^{{N}_{T} - 1} {Z}^{- m} {A}_{i , j}^{m} ( n ) {U}_{j} ( n ) \\ = {\sum }_{j = 0}^{{p}_{2} - 1} {\sum }_{m = 0}^{{N}_{T} - 1} {A}_{i , j}^{m} ( n - m ) {U}_{j} ( n - m )\end{matrix} & ( 65 )\end{matrix}$$

In the particular case where L=pM, p₂=1 and p₁=p and the conversion equation is reduced simply to

$${V}_{i} ( n ) = {\sum }_{m = 0}^{{N}_{T} - 1} {A}_{i}^{m} ( n - m ) X ( n - m ) \qquad ( 66 )$$

In these condition and taking into account the form B, a subsystem numbered i is obtained which determines the component Vᵢ(n) of the output signal as represented in FIG. 12C. The switch COM of the input travels the p₂ stages of this subsystem and performs the filtering operations characterized by the components A_{i,j}(Z,n) with i=0, . . . , p₂−1 of the main conversion matrix.

The conversion system in the general case and defined in the form B can be interpreted as a set of subsystems as represented in FIG. 12D. This structure comprises p₁ time-varying linear subsystems and the switch COM1 at the input is periodic of period p₂/fₓ. The subsystem numbered i with i=0, . . . , p₁−1, out of this set, is characterized by the p₂ filters A_{i,j}(Z,n) with j=0, . . . , p₂−1. These subsystems operate in parallel and one of their outputs is chosen periodically as output of the conversion system with a period p₁/f_{y}. The filtering coefficients of the main conversion matrix T(Z,n) vary with time and its changes of state are applied after each period of duration K/fₑ. The global system is therefore linear periodically time varying with a period K/fₑ with:

K=p₂L=p₁M and fₑ=Lfₓ=Mf_{y}

The two switches at the input COM1 and at the output COM2 of the structure of FIG. 12D operate with a frequency fₑ/K which is also the frequency of changes of state of the components A_{i,j}(Z,n).

The output Y(n) of the conversion, at the instant n/f_{y}, is equal to the output of the subsystem s-LPTV numbered i, at the instant n/f_{y}, when i=n mod p₁. The input X(n), at the instant k/fₓ, contacts the connections numbered j of each of the p₁ subsystems s-LPTV when j=k mod p₂.

There now follows a description of an embodiment based on lapped transformations. To this end, as in FR-2,875,351, B_{i,j}(n) (i=0, . . . , p₁−1 and j=0, . . . . , p₂−1) is used to denote matrices of size N_{T}M×L, “rearranged” and associated with each of the components A_{i,j}(n,Z) for the form A and associated with each of the components A_{i,j}(Z,n) for the form B, such that:

Form A

$${B}_{i , j} ( n ) = [ \begin{matrix}{A}_{i , j}^{0} ( n ) \\ {A}_{i , j}^{1} ( n + 1 ) \\ ⋮ \\ {A}_{i , j}^{{N}_{T} - 1} ( n + {N}_{T} - 1 )\end{matrix} ]$$

Form B:

$${B}_{i , j} ( n ) = [ \begin{matrix}{A}_{i , j}^{0} ( n ) \\ {A}_{i , j}^{1} ( n ) \\ ⋮ \\ {A}_{i , j}^{{N}_{T} - 1} ( n )\end{matrix} ]$$

With these definitions, the representations s-LPTV of the global systems according to FIGS. 12B and 12D respectively associated with the forms A and B, are naturally rearranged and lead to the diagram of FIG. 12E. The storage operations are performed after the matrix multiplications of the signals at the inputs by the matrices B_{i,j}(n). The blocks denoted OLA (for “overlap and add”) perform the storage and the final overlap and add operations of the vectors transformed by the matrices B_{i,j}(n). The calculation procedure for the conversion between sub-band fields is preferably done as follows:
each new vector X(n′) such that Uⱼ(n)=X(n′), with n′=np₂+j, is placed at the input of the matrix blocks B_{i,j}(n) (i=0, . . . , p₁−1);
for each fixed “number” i, there is applied:
   a matrix transformation of Uⱼ(n) by the matrix B_{i,j}(n),
   a summation of all the transformed vectors at the output of the matrices B_{i,j}(n) (j=0, . . . , p₂−1),
   an addition with overlap on these vectors, operation OLA being performed on vectors of length N_{T}M with an overlap of (N_{T}−1)M,
the output Y(n″) of the conversion system corresponds to the output Vᵢ(n) of the subsystem s-LPTV numbered i with n″=np₁+i.

It will be recalled that the matrices B_{i,j}(n) vary in time. From this important point, the processing operation conducted globally remains similar to that described in the document FR-2,875,351. FIG. 12E represents the global processing principle.

Generally, it will be remembered that the global conversion involves a transform with overlap and add, taking into account in particular a time trend in the quantities that are added with overlap.

### Exemplary Embodiments

There follows a description of the applications of the invention in the cases of MPEG-1/2, MPEG-2/4, Dolby AC-3, G722.1 (type TDAC of the applicant), audio coders, most of them standardized.

According to the characteristics of each of the filter banks used by these coders, a conversion system is obtained that generally corresponds to the case K=ppcm(L,M), but also with frequent occurrences of the two particular cases M=pL and L=pM. It may also happen that one of the banks of analysis or synthesis filters is time-invariant. Obviously, the cases where the two filter banks are time-invariant are routinely covered by the state of the art, notably in the document FR-2,875,351.

The table below summarizes the different cases observed with existing types of coders.

| | |
|---|---|
| Case M = pL | MPEG-1/2 layer I&II to MPEG-2/4 AAC (p = 32) |
| | MPEG-1/2 layer I&II to Dolby AC-3 (p = 8) |
| | Dolby AC3 to MPEG-2/4 AAC (p = 4) |
| Case L = pM | MPEG-2/4 AAC to MPEG-1/2 layer I&II(p = 32) |
| | Dolby AC3 to MPEG-1/2 layer I&II(p = 8) |
| | MPEG-2/4 AAC to Dolby AC-3 (p = 4) |
| Case K = ppcm(L, M) | MPEG-2/4 AAC to G722.1 (K = 5120, p₁, = 5, p₂= 16) |
| | Dolby AC3 to G722.1 (K = 1280, p₁ = 5, p₂ = 4) |
| | G722.1 to MPEG-2/4 AAC (K = 5120, p₁ = 16, p₂ = 5) |
| | G722.1 to Dolby AC-3 (K = 1280, p₁ = 4, p₂ = 5) |

It will be noted that the conversion cases where M=pL correspond to the particular cases where the numbers of “determinate” channels of the filter banks are integer multiples. It should be noted, in these cases, simply that K=M (p₁=1) and p₂=p.

Most of the representations used by the MPEG-2/4 AAC or Dolby AC-3 coders are defined by two dimensions denoted M₁ and M₂. Nevertheless, as shown previously, the two dimensions are, in an equivalent way, time-varying lapped transforms TV-MLT (defined as a function of the ratio M₁/M₂). Regarding the abovementioned coders, the cases M=pL implicitly indicate that the greatest dimension M₁ of the transform TV-MLT (with M₁/M₂) of the bank of analysis filters is a multiple of that (denoted L₁) of the transform TV-MLT (with L₁/L₂) of the bank of synthesis filters. More explicitly, it is possible to then consider a “conversion of the cases where M₁=pL₁”.

As an example, the conventional diagram of the conversion between the Dolby AC-3 audio coder and the MPEG-2/4 AAC coder is represented in FIG. 7, in which L₁=256 and M₁=1024, or therefore simply p=4 satisfying M₁=pL₁. Thus, the condition of proportionality applies only to the greatest dimension of the time-varying filter bank.

Example of Conversion Between a Filter Bank of Type P-QMF(L) and a Filter Bank of type TV-MLT(M₁/M₂) with L and M₁ that are Multiples

The case where the bank of synthesis filters is of type P-QMF(L) is considered, for a code conversion between a coder of MPEG-1/2 layer I and II type and a coder of MPEG-2/4 AAC type and/or a coder of MPEG-1/2 layer I and II type and a coder of Dolby AC-3 type.

It typically concerns two examples of conversion compliant with the case M=pL.

The bank of synthesis filters of the conventional diagram is time-invariant. It comprises L=32 sub-bands and the length of the filters is N_{f}=512. The transform TV-MLT(M₁/M₂) is defined by the values M₁/M₂=1024/128 for the MPEG-2/4 AAC coder and M₁/M₂=256/128 for the Dolby AC-3 coder. The characteristic constants of the conversion system are then found as follows:

| | MPEG-2/4 AAC | Dolby AC-3 |
|---|---|---|
| p | 32 | 16 |
| N_{T} | 4 | 3 |
| D_{f} | — | — |

The number Δ_{f} is not defined in this case since the filter bank P-QMF is time-invariant and, because of this, the matrix blocks of g(n,Z) are defined simply as:

$${g}_{i}^{A} ( n ) = {\sum }_{j}^{ } {h}_{j}^{{k}_{1}} ( n ) {f}_{i - j}^{{k}_{2}}$$

for i=0, . . . , (2M₁+N_{f}−1).

The index i is a simple convolution index and the coefficients of the synthesis filters do not vary.

Δ_{T} is used to denote the number of allowable states of the main conversion matrix T(n,Z). There are Δ_{T}=4 states that are possible and different for the time variations (index n) of the global matrix T(n,Z). The bank of analysis filters H(n,Z) in effect accepts four distinct states. Because of this, at an instant nM₁, the main conversion matrix T(n,Z) is constructed, on the one hand, from coefficients of the synthesis filter P-QMF(L) and, on the other hand:
from the coefficients of the transform TV-MLT defined by the relation (13), if the transform has long time resolution 2M₁;
or from coefficients of the transform TV-MLT defined by the relation (15), if the transform has short time resolution 2M₂;
or from coefficients of the transform TV-MLT defined by the relation (17), if the transform performs a change from long resolution 2M₁ to short resolution 2M₂;
or from coefficients of the transform TV-MLT defined by the relation (19), if the transform performs a change from short resolution 2M₂ to long resolution 2M₁.

The Δ_{T}=4 allowable states of the conversion matrix T(n,Z) are determined from the N_{T} blocks that are all of size M₁×M₁.

In the case of a reciprocal conversion with L₁=pM where the filter bank P-QMF(M) is the bank of analysis filters, whereas the transform TV-MLT(L₁/L₂) is the bank of synthesis filters, the conversion system is defined in the form B. The conversion matrix T(Z,n) accepts Δ_{T}=4 different states and each state is determined by N_{T} blocks comprising L₁×L₁ filtering coefficients.

If L₁/L₂=1024/128 (case of the MDCT transform of the MPEG-2/4 AAC coder), then N_{T}=4 and if L₁/L₂=256/128 (case of the MDCT transform of the Dolby AC-3 coder), then N_{T}=3.

Case of Transforms TV-MLT(L₁/L₂) and TV-MLT(M₁/M₂) with L₁ and M₁ that are Multiples

This is, for example, the case of the code conversion between the Dolby AC-3 audio coder and the MPEG-2/4 AAC coders. The conversion system corresponds to the particular case where M₁=pL₁ with L₁/L₂=256/128 and M₁/M₂=1024/128. The constants of the conversion system are therefore determined by

p=4 Δ_{f}=10 N_{T}=3

A state of the conversion matrix comprises N_{T}=3 blocks of filtering coefficients P₀(n), P₁(n), P₂(n). Each block of coefficients is of size 1024×1024.

It is shown that the maximum number of different states of the main conversion matrix T(n,Z) is equal to Δ_{T}=1152. This number is obtained from the value of the term uₖ of a Fibonacci series defined for the initial values u₁=4, u₂=6, when k=Δ_{f}. It was observed in effect that, generally, the number of possible states of matrix T followed the variations of a Fibonacci series. This number of different states Δ_{T} is determined assuming that the changes of state of the bank of synthesis filters F(Z,n) and those of the bank of analysis filters H(n,Z) are independent. Preferably, two independent switchover commands SW are provided, which control the changes of resolution of the two TV-MLT transforms. For the transform TV-MLT(L₁/L₂), this control is carried out at all instants that are multiples of LA and for the transform TV-MLT(M₁/M₂), this control is carried out at all instants that are multiples of M₁.

As indicated hereinabove, the switchover commands SW advantageously work on the basis of an analysis of the statistical properties of the incoming signal and determine, notably by perceptual entropy criteria, which are the resolutions most suited for each block of length 2L₁ or 2M₁. These commands are at least partly coherent and some changes of resolution of the transform TV-MLT(L₁/L₂) advantageously occur synchronously with those of the transforms TV-MLT(M₁/M₂). For example, if the transform TV-MLT(L₁/L₂) proceeds over several periods, by transforms of resolution L₂, the transform TV-MLT(M₁/M₂) does not, a priori, carry out a change of resolution M₂→M₁ or does not use states defined by the resolution M₁. It should therefore be specified that the number of allowable states Δ_{T}=1152 is maximum because certain states out of the Δ_{T} states are no longer allowable if they are no longer coherent relative to the operation of the code converter's transition control.

For the case of the conversion occurring in the code conversion between the MPEG-2/4 AAC format and the Dolby AC-3 format, L₁=pM₁ with p=4 and the conversion system is defined in the form B. The construction of the matrix g(Z,n) entails performing groupings of Δₕ=10 successive states of the transform TV-MLT(M₁/M₂). Each state of the conversion matrix T(Z,n) is determined by the datum N_{T}=4 blocks of 1024×1024 coefficients. A maximum total of 1022 different allowable states can be counted for the conversion matrix.

TDAC(L) Coder and TV-MLT(M₁/M₂) Transform with K=ppcm(L,M₁)

In the case where the bank of synthesis filters is a bank of TDAC type filters comprising L=320 sub-bands, each filter being of length N=640, there is no multiplicity between the dimension L and the dimension M₁=1024 of the MPEG-2/4 AAC coder, or between the dimension L and the dimension M₁=256 of the Dolby AC-3 coder. In these two conversion cases, the conversion system is determined by the value of K=ppcm(L, M₁) such that K=5120 with the MPEG-2/4 AAC coder and K=1280 with the Dolby AC-3 coder. The system can be implemented in the form A or in the form B.

In the case of an implementation in the form A, there are four allowable states for the filtering submatrix g(n,Z) because the coefficients of the bank of synthesis filters are time invariant, whereas those of the bank of analysis filters relating to the transform TV-MLT(M₁/M₂) accept four different definitions. For the construction of the main matrix, p₁ successive states of g(n,Z) are grouped together in order to construct a state of T(n,Z). Assuming that the rules governing changes of state of g(n,Z) are the same as those for the transform TV-MLT(M₁/M₂), the total number of states Δ_{T} of T(n,Z) is deduced from the values of a Fibonacci series. The result is therefore Δ_{T}=uₖ, calculated with k=p₁.

In the case of the code conversion involving the MPEG-2/4 AAC coder, p₁=16 and Δ_{T}=8362. A state of the conversion matrix comprises N_{T}=1 single block with 5120 coefficients.

In the case of the code conversion involving the Dolby AC-3 format, p₁=4 and Δ_{T}=26. A state of the conversion matrix comprises N_{T}=1 single block with 1280 filtering coefficients.

Obviously, the present invention is not limited to the embodiment described hereinabove by way of example; it applies to other variants.

Generally, the invention applies to any code conversion between coding formats, notably audio, using time-varying filter banks. These code converters can be implemented in gateways, notably in telecommunication network nodes, or in multimedia content servers in the context of so-called “streaming” mode broadcasting applications, or applications for downloading or for broadcasting for digital television (MPEG-4 AAC format to an MPEG-2 Layer II or Dolby AC-3 format), or others.

It can also be applied to any implementation for a transition between two sub-band representations, notably within coders in the MPEG-4 HE-AAC and/or MPEG Surround Audio Coding format.

Moreover, most of the coding formats indicated hereinabove work on digital audio signals, but the present invention applies to any type of time-varying code conversion and works on any type of signal.

1. A method implemented by computer resources to process a signal by transition between different sub-band fields,
aiming to compact in one and the same processing operation the application of a first vector representing the signal in a first sub-band field to a bank of synthesis filters, then to a bank of analysis filters, to obtain a second vector representing the signal in a second sub-band field, wherein provision is made for the application of a matrix filtering to the first vector to directly obtain the second vector,
wherein:
the synthesis bank and/or the analysis bank are time-varying,
the matrix filtering is represented by a global conversion matrix comprising matrix sub-blocks:
precalculated by taking into account the possible variations in time of the filter banks,
and stored in memory,
and the global conversion matrix is constructed for each call to said memory to obtain said precalculated sub-blocks at successive instants.

2. The method as claimed in claim 1, wherein the global conversion matrix is constructed progressively by calls to said memory at successive instants for which said sub-blocks have been precalculated.

3. The method as claimed in claim 1, wherein, the first vector comprising a first number L of components in respective sub-bands whereas the second vector comprises a second number M of components in respective sub-bands, after determination of a third number K, the smallest common multiple between the first number L and the second number M:
a serial/parallel conversion of the first vector is applied to obtain p₂ polyphase component vectors with p₂=K/L, and
a parallel/serial conversion is applied to obtain said second vector,
wherein:
the conversion matrix is applied to said p₂ polyphase components of the first vector to obtain p₁ polyphase components of the second vector with p₁=K/M, and
the conversion matrix is square, of dimension K×K, and comprises p₁ rows and p₂ columns of sub-blocks Aᵢⱼ each comprising L rows and M columns,
and wherein the sub-blocks Aᵢⱼ of one and the same index i or sub-blocks Aᵢⱼ of one and the same index j are precalculated for one and the same instant.

4. The method as claimed in claim 3, wherein the conversion matrix is three-dimensional, with:
a first dimension defined by the current index i of the sub-blocks,
a second dimension defined by the current index j of the sub-blocks,
and a third dimension defined by a degree of matrix filtering,
and the sub-blocks precalculated for one and the same instant form matrix planes extending towards said third dimension.

5. The method as in claim 3, wherein the sub-blocks Aᵢⱼ are each expressed:
as a function of the matrix type g(n,Z), the elements of which are given by:
$${( g ( n , Z ) )}_{{k}_{1} , {k}_{2}} = {\sum }_{i = 0}^{{N}_{h} + {N}_{f} - 1} {g}_{i}^{{k}_{1} , {k}_{2}} ( n ) {Z}^{- i} ,$$
or, in an equivalent manner, as a function of a matrix type g(Z,n), the elements of which are given by:
$${( g ( Z , n ) )}_{{k}_{1} , {k}_{2}} = {\sum }_{i = 0}^{{N}_{h} + {N}_{f} - 1} {Z}^{- i} {g}_{i}^{{k}_{1} , {k}_{2}} ( n ) ,$$
where:
Nₕ is the length of the analysis filters,
N_{f} is the length of the synthesis filters,
n is a time variable,
Z is a transform domain variable,
k₁ is between 0 and M−1 and k₂ between 0 and L−1, and
the coefficients gᵢ^{k}^{₁}^{k}^{₂}(n), in each case, are expressed as a function of the coefficients of the analysis and synthesis filters.

6. The method as claimed in claim 5, wherein:
each sub-block of index i, expressed as a function of a matrix of type g(n,Z) is given by:
Aᵢⱼ(n,Z)=[g(n+iM,Z)Z^{ïM-jL}]|_{↓K}
where the notation ↓K designates a decimation of a factor K,
the matrix planes comprise sub-blocks of the same row index i and are horizontal,
and the global conversion matrix comprises said horizontal matrix planes precalculated for p₁ successive instants.

7. The method as claimed in claim 5, wherein:
each sub-block of index j, expressed as a function of a matrix of type g(Z,n), is given by:
Aᵢⱼ(Z,n)=[Z^{ïM-jL}g(Z,n+jL)]|_{↓K},
where the notation ↓K designates a decimation of a factor K,
the matrix planes comprise sub-blocks of the same column index j and are vertical,
and the global conversion matrix comprises said vertical matrix planes precalculated for p₂ successive instants.

8. The method as claimed in claim 5, wherein the number M is a multiple of the number L, and each sub-block is expressed as a function of a matrix of type g(n,Z).

9. The method as claimed in claim 5, wherein the number L is a multiple of the number M, and each sub-block is expressed as a function of a matrix of type g(Z,n).

10. The method as claimed in claim 5, wherein, the signal to be processed being digital and initially sampled at a period Tₑ, the global conversion matrix is determined periodically for instants that are multiples of a quantity KTₑ and is expressed as a function of matrices of type g (n,Z), calculated for successive instants that are multiples of a quantity MTₑ.

11. The method as claimed in claim 10, wherein the calculation of the coefficients of each matrix of type g(n,Z) at an instant that is a multiple of the quantity MTₑ is performed by taking:
Δ_{f} successive sets of coefficients of the bank of synthesis filters determined for Δ_{f} successive instants in a period MTₑ, and from an instant that is a multiple of MTₑ,
and a set of coefficients of the bank of analysis filters determined for said instant that is a multiple of MTₑ,
and by applying a partial convolution between said successive sets of coefficients of the synthesis bank and the coefficients of the analysis bank,
with Δ_{f}=[(Nₕ+N_{f}−1)/L]+1, where Nₕ and N_{f} are the respective lengths of the analysis and synthesis filters.

12. The method as claimed in claim 5, wherein, the signal to be processed being digital and sampled at a period Tₑ, the global conversion matrix is determined periodically for instants that are multiples of a quantity KTₑ and is expressed as a function of matrices of type g(Z,n), calculated for successive instants that are multiples of a quantity LTₑ.

13. The method as claimed in claim 12, wherein the calculation of the coefficients of each matrix of type g(Z,n) at an instant that is a multiple of the quantity LTₑ is performed by taking:
Δₕ successive sets of coefficients of the bank of analysis filters determined for Δₕ successive instants in a period LTₑ, and from an instant that is a multiple of LTₑ,
and a set of coefficients of the bank of synthesis filters determined for said instant that is a multiple of LTₑ,
and by applying a partial convolution between said successive sets of coefficients of the analysis bank and the coefficients of the synthesis bank,
with Δₕ=[(Nₕ+Nⱼ−1)/M]+1, where Nₕ and N_{f} are the respective lengths of the analysis and synthesis filters.

14. The method as claimed in claim 1, wherein provision is made for a finite number of possible states with which are associated respective sets of coefficients of the synthesis and/or analysis banks,
and said sub-blocks are precalculated from said respective sets for all the possible states, whereas the global conversion matrix is determined for at least one possible state defined from properties of the signal to be processed.

15. The method as claimed in claim 14, wherein each set is calculated as a function of a modulation matrix and of a vector h characterizing a possible state and ensuring a perfect or almost-perfect reconstruction property.

16. The method as claimed in claim 15, wherein the synthesis and/or analysis banks are time-varying by changes of resolution, and wherein four possible states are counted, said vectors h defining:
a long window corresponding to a first possible state,
a succession of short windows corresponding to a second possible state,
a transition window from the long window to the succession of short windows corresponding to a third possible state, and
a transition window from the succession of short windows to the long window corresponding to a fourth possible state.

17. The method as claimed in claim 3, wherein there is taken into account and consequently applied a control of an algorithmic delay produced by a processing of the signals in sub-bands.

18. The method as claimed in claim 1, wherein the global conversion uses a lapped transform with addition, taking into account a time trend in the quantities that are added.

19. A device for processing a signal by transition between different sub-band fields, wherein it comprises, to implement the method as claimed in claim 1:
a memory storing the precalculated sub-blocks,
a clock for determining successive instants, and
a matrix filtering module arranged to recover from said memory the sub-block precalculated for said successive instants for the construction of the global conversion matrix.

20. The device as claimed in claim 19, for implementing the method as claimed in claim 14, wherein it also comprises a switchover control for:
defining, from the signal to be processed, one of said possible states and associated sets of coefficients, and
managing access to said memory as a function of the defined state.

21. The device as claimed in claim 19, for implementing the method as claimed in claim 3, wherein it also comprises:
a serial/parallel converter upstream of the matrix filtering module, and
a parallel/serial converter downstream of the matrix filtering module.

22. The device as claimed in claim 19, wherein it is incorporated in equipment such as a server, a gateway, or even a terminal, intended for a communication network.

23. A computer program, intended to be stored in a memory of a device as claimed in claim 19, wherein it comprises instructions for implementing the method as claimed in claim 1.
